(19) United States
(12) Patent Application Publication
(10) Pub. No.: US 2011/0104404 A1
(43) Pub. Date: May 5, 2011

(54) Ceramic for Decorative Part and Decorative Part Comprising the Same

(75) Inventor: Kenichi Hamamura, Kirishima-shi (JP)

(73) Assignee: KYOCERA CORPORATION, Kyoto-shi, kyoto (JP)

(21) Appl. No.: 12/934,637

(22) PCT Filed: Mar. 23, 2009
(86) PCT No.: PCT/JP2009/055615

§ 371 Date: Jan. 18, 2011

(30) Foreign Application Priority Data
Mar. 24, 2008 (JP) 2008-075827

(51) Int. Cl. C04B 35/58; A44C 5/00; A01K 87/04; B60R 13/00

(52) U.S. Cl. 428/31; 428/325

(57) ABSTRACT

A ceramic for decorative parts is provided which has excellent wearing resistance and can retain over long a gold color tone capable of giving a high-grade feeling, a feeling of aesthetic satisfaction, and spiritual comfortableness. Also provided is a decorative part comprising the ceramic. The ceramic for a decorative part is characterized by comprising 50 mass % or more titanium nitride, 6 mass % or more and 30 mass % or less unstabilized zirconia containing substantially no stabilizer, and nickel, the unstabilized zirconia having a crystal grain size smaller than the crystal grain size of the titanium nitride.

### TECHNICAL FIELD

The present invention relates to a ceramic for a decorative part having golden color of beautiful color tone and high wear resistance, and a decorative part comprising the same. Particularly, the present invention relates to a decorative part for a fish line (fishing line) guide, a decorative part for a watch, a decorative part a for mobile terminal, a decorative part for an accessory, a decorative part for a vehicle part, a decorative part for sports goods, a decorative part for a musical instrument and a decorative part for a daily life article, and a ceramic for decorative part used in these parts.

### BACKGROUND ART

Heretofore, decorative parts used in fish line guides or watches have been formed from metallic materials. However, these metallic materials had a problem that they are inferior in scratch resistance and corrosion resistance and the surface of the decorative part comprising these materials is likely to be damaged, and thus the decorative value of the part would be gradually impaired.

It has been conceived to form a base layer on the substrate surface and form a DLC (diamond-like carbon) film on the base layer by CVD (chemical vapor deposition) using plasma discharge, thereby to render complex hues and color tones. However, the coating layer formed from the DLC film by CVD is likely to be peeled and damaged, and is not suitable for decorative parts.

To solve the problems described above, ceramics having high wear resistance have been used for decorative parts such as fish line guide or watch. The present inventors disclosed, in Patent Document 1, sintered ceramics constituted from a first hard phase containing nitride of titanium, a second hard phase containing at least one kind of alumina and zirconia, and a binder phase containing nickel. The sintered ceramics undergo volume expansion as the surface layer of the first hard phase containing the nitride of titanium turns into oxide by the sliding motion in a wet condition or dry condition. However, since the second hard phase protects the first hard phase so that the first hard phase does not come off due to volume expansion, high wear resistance can be obtained. Patent document 1 shows that this sintered ceramics can be applied to decorative parts for fish line guide and decorative part for watch.
Patent Document 1: WO 05/093110

### DISCLOSURE OF THE INVENTION

### Problems to be Solved by the Invention

However, the decorative part for fish line guide is required to have further higher wear resistance, and there have been such situations where the requirement for the wear resistance cannot be satisfied by the sintered ceramics disclosed in Patent Document 1. Recently, attempts have been made to use the sintered ceramics not only for decorative part for watch but also for various keys of mobile terminals which are pressed to operate. Such decorative parts that are worn or carried by a user are required to have capability to suppress the color tone from changing due to oxidization caused by deposition of sweat or moisture, and wear resistance high enough to suppress scratches from being generated by rubbing.

Moreover, there are such cases where the decorative part is required to have golden color tone that provides high-grade impression, aesthetic satisfaction and mind soothing effect.

The present invention has been devised to solve the problems described above, and object thereof is to provide ceramics for decorative parts, which can maintain golden color tone that has high wear resistance and provides high-grade impression, aesthetic satisfaction and mind soothing effect over a long period of time, and various decorative parts such as a decorative part for fish line guide, a decorative part for watch and a decorative part for mobile terminal that use the ceramics for decorative parts.

### Means for Solving the Problems

One aspect of the present invention is a ceramic for decorative part, comprising 50% by mass or more of titanium nitride, 6 by mass or more and 30% by mass or less of unstabilized zirconia that contains substantially no stabilizing agent, and nickel, wherein the crystal grain size of the unstabilized zirconia is smaller than the crystal grain seize the titanium nitride.

### Effects of the Invention

The ceramic for a decorative part of the present invention contains titanium nitride as the main component (50% by mass or more), 6% by mass or more and 30% by mass or less of unstabilized zirconia that contains substantially no stabilizing agent, and nickel, wherein the crystal grain size of the unstabilized zirconia is smaller than the crystal grain size of the titanium nitride. With this constitution, the unstabilized zirconia undergoes volume expansion when the ceramic is cooled down to the room temperature (normal temperature) after being heated to a high temperature and sintered, so that the crystal grains of titanium nitride are subjected to a high compressive stress due to the volume expansion, and are suppressed from coming off. As a result, it is made possible to provide a ceramic for decorative part, which has improved wear resistance and shows golden color tone that provides the user with high-grade impression, aesthetic satisfaction and mind soothing effect over a long period of time.

### BRIEF DESCRIPTION OF THE DRAWINGS

FIG. 1 shows a fish line guide ring that is a decorative part for fish line guide of the present invention, and an example of a fish line guide provided with the fish line guide. ring, FIG. 1(a) is a plan view of the fish line guide ring, and FIG. 1(b) is a perspective view of a fish line guide having the fish line guide ring shown in FIG. 1(a).

FIG. 2 shows an example of watch case which is a decorative part for watch of the present invention, FIG. 2(a) in a perspective view of the front surface of the watch case, and FIG. 2(b) is a perspective view of the back surface of the watch case of FIG. 2(a).

FIG. 3 is a perspective view showing another example of watch case which is a decorative part for watch of the present invention.

FIG. 4 is a schematic diagram showing an example of constitution of the watchband which is a decorative part for watch of the present invention.

FIG. 5 is a perspective view showing an example of mobile phone that uses a decorative part for mobile terminal of the present invention.

FIG. 6 is a perspective view showing the mobile phone shown in FIG. 5 in a state of chassis opened.

FIG. 7 is a schematic diagram showing an example of constitution of a soap case as an example of the decorative part for daily life articles of the present invention.

FIG. 8 is a schematic diagram showing an example of constitution of a coffee cup set as another example of the decorative part for daily life articles of the present invention.

FIG. 9 is a perspective view showing an example of vehicle body having the decorative part for vehicle parts of the present invention mounted thereon.

FIG. 10 is a front view showing an example of corner pole that uses the decorative part for vehicle parts of the present invention.

FIG. 11 is a front view showing an example of golf club that uses the decorative part for sports goods of the present invention.

FIG. 12 is a bottom view showing an example of spike shoes that use the decorative part for sports goods of the present invention.

FIG. 13 is a perspective view showing an example of guitar that uses the decorative part for musical instrument of the present invention.

FIG. 14 is a schematic cross section view showing an example of artificial dental crown that uses the decorative part for accessory of the present invention.

FIG. 15 is a front view showing an example of earphone unit that uses the decorative part for accessory of the present invention.

FIG. 16 is a perspective view showing an example of eyeglass that uses the decorative part for accessory of the present invention.

FIG. 17 is a schematic diagram showing the constitution of a wear resistance evaluation apparatus used to evaluate wear resistance of the ceramics for decorative part of the present invention.

### DESCRIPTION OF REFERENCE NUMERALS

1: Fish line guide ring
2: Holding section
3: Support
4: Mount
5: Frame
6: Fish line guide
10A, 10B: Watch case
11: Recess
12: Protrusion
13: bottom
14: wall
15: Hole
20: Inner link
21: Though hole
30: Outer link
31: Pin hole
40: Pin
50: Watchband
60: Mobile phone
90: Soap Case
100: Coffee cup set
110: vehicle body
120: Golf club
130: Spike shoes
140: Guitar
260: Earphone unit
170: Eyeglasses

### EMBODIMENTS FOR CARRYING OUT THE INVENTION

### 1. Ceramics for Decorative Part

Exemplary embodiments of the ceramics for decorative part of the present invention will be described below.

The ceramics for decorative part of the present invention contains titanium nitride as the main component (50% by mass or more), 6% by mass or more and 30% by mass or less of unstabilized zirconia which contains substantially no stabilizing agent, and nickel, wherein the crystal grain size (the size of crystal grains) of the unstabilized zirconia is smaller than the crystal grain size (the size of crystal grains) of the titanium nitride.

As described in detail hereinafter, the unstabilized zirconia undergoes volume expansion due to phase transition (phase transformation) when the ceramics is cooled down to the room temperature after being heated to a high temperature and sintered. The volume expansion puts the crystal grains of titanium nitride under a high compressive stress so as not to come off easily. Thus the ceramics for decorative part of the present invention, that is capable of suppressing the crystal grains of titanium nitride, which has wear resistance and desired golden color tone, from coming off, and therefore provides high wear resistance, high-grade impression, aesthetic satisfaction and mind soothing effect over a long period of time.

The ceramics for decorative part of the present invention will be described in detail below.

### Titanium Nitride

The ceramics for decorative part of the present invention contains titanium nitride as a main component.

The term main component as used herein means a component that occupies 50% by mass or more based on 100% by mass of all components constituting the ceramics for decorative part. Titanium nitride, which is the main component, shows golden color tone that is advantageous for decorative part, has high mechanical properties such as strength and hardness and high wear resistance. It is preferable that the ceramics for decorative part of the present invention contains 70% by mass or more titanium nitride.

### Zirconia

The unstabilized zirconia that contains substantially no stabilizing agent (hereafter referred to simply as unstabilized zirconia) means that it does not contain a material known as a stabilizing agent for zirconia such as calcium oxide, magnesium oxide, yttrium oxide, cerium oxide, neodymium oxide or dysprosium oxide intentionally added thereto, and does not exclude the presence of such a stabilizing agent as an inevitable impurity. When the stabilizing agent is present as inevitable impurity, the content of inevitable impurity is preferably 1% by mass or less based on 100% by mass of all components that constitute the ceramics for decorative part.

The ceramics for decorative part of the present invention contain 6% by mass or more and 30% by mass or less unstabilized zirconia based on 100% by mass of all components, for the following reason.

When sweat, muddy water or the like deposits on ceramics that contains titanium nitride as the main component, surface layer of titanium oxide is oxidized and turns into titanium oxide, while undergoing volume expansion and making crystal grains of titanium nitride likely to come off. However, crystal grains of titanium nitride can be suppressed from coming off when unstabilized zirconia is contained 6% by mass or more and 30% by mass or less, for the following reason.

At the room temperature, unstabilized zirconia has a monoclinic crystal structure, and undergoes phase transition to tetragonal and then cubic crystal structure while shrinking in volume when heated for sintering. When a cubic crystal structure formed at a high temperature is cooled down, it undergoes phase transition to tetragonal crystal structure and then monoclinic crystal structure while expanding in volume. As a result, in the ceramics for decorative part of the present invention containing 6% by mass or more and 30% by mass or more stabilized zirconia, the unstabilized zirconia undergoes volume expansion due to phase transition in the process of cooling down to the room temperature after sintering, thereby applying compressive stress to titanium nitride. Since crystal grains of titanium nitride in a state where high compressive stress is applied at the room temperature are suppressed from undergoing volume expansion caused by oxidization of the surface layer, the crystal grains of titanium nitride can be suppressed from coming off. The presence of the unstabilized zirconia having high wear resistance in the surface layer also can improve wear resistance of the ceramics for decorative part.

On the other hand, when the content of unstabilized zirconia is less than 6% by mass, the effect of suppressing volume expansion from being caused by oxidization of the surface layer of the ceramics for decorative part and the effect of suppressing crystal grains of titanium nitride from coming off decrease. When the content of unstabilized zirconia is more than 30% by mass, the unstabilized zirconia easily undergoes volume expansion when cooled down, and the compressive stress applied to the crystal grains of titanium nitride becomes too high, thus resulting in the possibility of cracks to occur in the obtained ceramics for decorative part that is produced.

To increase the above effects of suppressing the crystal grains of titanium nitride from coming off due to volume expansion of unstabilized zirconia while improving the wear resistance and prevent cracks from occurring, it is preferable to increase the content of unstabilized zirconia based on 100% by mass of all components that constitute the ceramics for decorative part within the range of 6% by mass or more and 30% by mass or less to a level of 11% by mass or more and 30% by mass or less.

The content of the unstabilized zirconia in the ceramics for decorative part can be determined as follows.

First, content of element zirconium (Zr) is measured by fluorescent X-ray spectrometry or inductively coupled plasma (ICP) emission spectrometry. The obtained content of element zirconium is converted to the weight of oxide (zirconia), so as to determine the content of total zirconia containing unstabilized zirconia and stabilized zirconia.

Then, (111) and (11-1) reflection peak intensities of monoclinic zirconia and (111) reflection peak intensities of tetragonal zirconia and cubic zirconia measured by X-ray diffraction are used to calculate the ratio Xm of unstabilized zirconia to the total zirconia (sum of unstabilized zirconia and stabilized zirconia) by the following formula (1).

(111) reflection intensity of monoclinic zirconia is denoted Im(111), (11-1) reflection intensity of monoclinic zirconia is denoted Im(11-1), and (111) reflection intensity of tetragonal zirconia and cubic zirconia is denoted Itc(111).

Xm (%)={(Im(111)+(Im(11-1))/(Im(111)+(Im(11-1)+Itc(111))}×100 (1)

The content of unstabilized zirconia can be determined by formula (2) from the ratio Xm of unstabilized zirconia to the content of total zirconia.

The content of unstabilized zirconia=Total zirconia content×Xm/100 (2)

In the ceramics for decorative part of the present invention, the crystal grain size of unstabilized zirconia is smaller than the crystal grain size of titanium nitride.

This constitution prevents the ceramics for decorative part of the present invention from deteriorating the golden color tone of the titanium nitride due to the presence of unstabilized zirconia. Since the crystal grains of titanium nitride are subjected to a compressive stress generated by the volume expansion of the unstabilized zirconia when the ceramics is cooled down to the room temperature after being heated to a high temperature and sintered as described above, the crystal grains of titanium nitride would not easily come off, thus making it possible to improve wear resistance.

In contrast, when the crystal grain size of unstabilized zirconia are larger than the crystal grain size of titanium nitride, the large crystal grains of unstabilized zirconia that have white color (not the desired golden color) appear on the surface, thus making it difficult to render satisfactory golden color tone to the surface of the ceramics for decorative part which is affected by white portions. When the crystal grain size of unstabilized zirconia are larger than the crystal grain size of titanium nitride, in addition, volume expansion of the unstabilized zirconia causes local increase in the compressive stress generated in the crystal grains of titanium nitride, which may cause cracks in the sintered material that makes the ceramics for decorative part.

In the ceramics for decorative part of the present invention, it is preferable that the crystal grain size of unstabilized zirconia is 0.1 times to 0.5 times the crystal grain size of titanium nitride.

When the crystal grain size of unstabilized zirconia is 0.1 times or more and 0.5 times or less the size of the crystal grain size of titanium nitride, the effect of suppressing crystal grains of titanium nitride from coming off by the compressive stress applied to the crystal grains of titanium nitride due to volume expansion of the unstabilized zirconia becomes more conspicuous, and the wear resistance can be improved further.

When the crystal grain size of unstabilized zirconia that has white color is controlled to 0.5 times or less the crystal grain size of titanium nitride, the influence on the color tone of the ceramics for decorative part can be mitigated. Therefore, the ceramics for decorative part having color tone defined by the golden color of titanium nitride can be made, thus providing the ceramics for decorative part having high wear resistance and high decorative value.

The crystal grain size of titanium nitride is the mean value of the size (diameter) of the crystal grains of titanium nitride measured by analyzing an image obtained under a scanning electron microscope (SEM) with a magnification of 4,000 to 6,000 times. As the crystal grain size of unstabilized zirconia, mean size of zirconia crystal grains may be used that is determined by analyzing an image obtained under an SEM with a magnification of 4,000 to 6,000 times similarly to the case of crystal grains of titanium nitride, since most of zirconia present in the ceramics for decorative part of the present invention is unstabilized zirconia.

### Nickel

The ceramics for decorative part of the present invention contain nickel.

Nickel serves as a binder that makes a bond between crystal grains of titanium nitride firm, thus making it possible to improve fracture toughness. The content of nickel also exerts an influence on surface gloss of the ceramics for decorative part.

The content of nickel is preferably 4% by mass or more and 8% by mass or less. When the content of nickel is 4% by mass or more and 8% by mass or less, since crystal grains of titanium nitride are bonded more firmly with each other, fracture toughness can be more improved. When the content of nickel is in a range of 4% by mass or more and 8% by mass or less, since silver color of nickel scarcely exerts an adverse influence on golden color of titanium nitride, the surface of the ceramics for decorative part can easily have desired gloss with golden color.

The content of nickel can be determined by fluorescent X-ray spectrometry or ICP emission spectrometry.

### Other Components

The ceramics for decorative part of the present invention containing titanium nitride as the main component, and unstabilized zirconia and nickel can also contain inevitably impurities such as silicon, phosphorus, sulfur, manganese, iron, cobalt, niobium and molybdenum. The content of each impurity element is preferably 1% by mass or less based on 100% by mass of all components that constitute the ceramics for decorative part.

It is preferred that manganese is contained. Manganese may be added so as to contain for intended purposes by the following reason. Since manganese has large ionization tendency and has a strong oxygen adsorption action, inclusion of manganese inhibits oxidation of granules of a mixed material containing titanium nitride, unstabilized zirconia and nickel obtained by spray drying and to inhibit variations in color tone of the obtained ceramics for decorative part of the decorative surface. Preferred content of manganese is 0.2% by mass or more and 0.4% by mass or less. When the content of manganese is 0.2% by mass or more, the granules are scarcely oxidized. In contrast, when the content of manganese is 0.4% by mass or less, an influence of silver-white color peculiar to manganese is not exerted.

The presence or absence, and content of manganese in the ceramics for decorative part can be determined by fluorescent X-ray spectrometry or inductively coupled plasma (ICP) emission spectrometry.

It is preferable that the ceramics for decorative part of the present invention contain chromium. Chromium is bonded with oxygen in air to form a dense oxide film on the decorative surface, thus making it possible to improve corrosion resistance. Therefore, when the ceramics for decorative part of the present invention contain chromium, it is possible to continuously provide the user with high-grade impression, aesthetic satisfaction and mind soothing effect over a long period of time.

The presence or absence of chromium can be confirmed by X-ray diffraction method or fluorescent X-ray spectrometry. Chromium may be present in the form of chromium carbide. It is preferable that calculation is performed assuming that entire chromium is present in the form of chromium carbide and thus the content of chromium carbide is 5% by mass or less based on 100% by mass of all components that constitute the ceramics for decorative part. The content of chromium may be determined by fluorescent X-ray spectrometry or inductively coupled plasma (ICP) emission spectrometry.

### Other Properties

In the ceramics for decorative part of the present invention, as described above, compression stress is applied to crystals of titanium nitride. The compression stress is preferably 350 MPa or more. When the compression stress is 350 MPa or more, since crystal grains of titanium nitride are less likely to come off, it is possible to obtain ceramics for decorative part having more improved wear resistance.

Details are illustrated in the description about the method for manufacturing ceramics for decorative part. For example, it is possible to control the compression stress to 350 MPa or more by adjusting the temperature at which sintering is performed so as to obtain ceramics for decorative part, namely, the firing temperature in a range of 1600° C. or higher and 1650° C. or lower.

The compression stress can be determined by the 2D method using an X-ray diffractometer (for example, D8 DISCOVER with GADDS Super Speed or new model thereof, manufactured by Bruker AXS Corporation).

It is preferable that the ceramics for decorative part of the present invention has lightness index L* in a range of 60 or more and 70 or less, chromaticness index a* in a range of 6.0 or more and 8.2 or less, and chromaticness index b* in a range of 16.5 or more and 24.5 or less in the L*a*b* color space of CIE1976 of the decorative surface. The ceramics for decorative part having the indices in these ranges has golden color of satisfactory brightness and clearness and provides the user with high-grade impression, aesthetic satisfaction and mind soothing effect.

In the present invention, the decorative surface of the ceramics for decorative part refers only to a surface of a decorative part which is required to have decorative value, and does not mean the entire surface since it is unnecessary to include the surface to which decorative value is not required. For example, in case the ceramics for decorative part of the present invention is used in a watch case, the outside surface of the watch case is subjected to aesthetic evaluation and is required to have decorative value, and is therefore referred to as the decorative surface, but the inner surface in which the drive mechanism of the watch is fitted is not usually required to have decorative value, and is not included as the decorative surface.

The lightness index L* in the L*a*b* color space of CIE1976 indicates the degree of lightness or darkness of a color tone, while a higher value of the lightness index L* means lighter color tone and a lower value of the lightness index L* means darker color tone. In the ceramics for decorative part of the present invention, the value of lightness index L* is preferably in a range of 60 or more and 70 or less, which ensures golden color of satisfactory brightness. When the value of lightness index L* is lower than 60, the color becomes darker and likely fails to provide aesthetic satisfaction. When the value of lightness index L* exceeds 70, the color tone becomes too bright and impairs the high-grade impression. It is particularly preferable that lightness index L* is in a range of 63 or more and 67 or less, which enables it to achieve the effects described above more stably.

In order to make the ceramics for decorative part of the present invention having lightness index L* of 60 or more, it is preferable that the decorative surface has open porosity (open void ratio) of 3% or less, since open porosity in the decorative surface has an influence on the brightness of the color tone. To achieve lightness index L* of 63 or higher, it is preferable that the decorative surface has open porosity of 2.5% or less. To achieve lightness index L* of 65 or higher, it is preferable that the decorative surface has open porosity of 1.1% or less.

In case the dry pressure molding process is employed to form the granules of prepared material, service life of the molding die can be elongated and open porosity of 3% or less can be achieved by setting the molding pressure in a range of 49 MPa to 196 MPa, as will be described in detail later. The open porosity of 2.5% or less can be achieved by setting the molding pressure in a range of 62 MPa or more and 196 MPa or less. The open porosity of 1.1% or less can be achieved by setting the molding pressure in a range of 98 MPa or more and 196 MPa or less.

The chromaticness index a* in the L*a*b* color space of CIE1976 indicates the position in red to green axis of color tone. A larger positive value of chromaticness index a* means red color, and a smaller absolute value of chromaticness index a* means dull color tone without clearness, while a negative chromaticness index a* having a larger absolute value means green color.

In the ceramics for decorative part of the present invention, it is preferable that chromaticness index a* is in a range of 6.0 or more and 8.2 or less, which produces clear color tone by suppressing the coloration toward red color. When chromaticness index a* is less than 6.0, the color tone loses clearness. When chromaticness index a* has a negative value of larger absolute value, the color tone becomes greenish although it is clear. When chromaticness index a* exceeds 8.2, the color tone becomes increasingly reddish and gives flash impression at the cost of high-grade impression.

For example, chromaticness index a* can be controlled within a range of 6.0 or more and 8.2 or less by polishing the ceramics for decorative part obtained by sintering, by barrel polishing or lapping operation so that surface roughness falls within a range of 0.05 μm or more and 0.23 μm or less in terms of an arithmetic mean height Ra.

The chromaticness index b* in the L*a*b* color space of CIE1976 indicates the position in yellow to blue axis of color tone. A larger positive value of chromaticness index b* means yellow color tone, and a smaller absolute value of the index b* means dull color tone without clearness, while a negative chromaticness index b* having a larger absolute value means blue color. In the ceramics for decorative part of the present invention, it is preferable that chromaticness index b* is in a range of 16.5 or more and 24.5 or less, which produces clear golden color tone. When chromaticness index b* is less than 16.5, the color tone loses clearness. When chromaticness index b* exceeds 24.5, the color tone becomes increasingly yellowish with weaker golden color tone, which may fail to satisfy some users who feel it likely lacks high-grade impression, aesthetic satisfaction and mind soothing effect.

Chromaticness index b* can be controlled within a range of 16.5 or more and 24.5 or less by the polishing operation described above so that surface roughness of the ceramics for decorative part falls within a range of 0.05 μm or more and 0.23 μm or less in terms of an arithmetic mean height Ra.

The titanium nitride of the ceramics for decorative part of the present invention preferably has such a composition, when represented by TiNₓ, that x is in a range of 0.8≦x≦0.96. As the value of atomicity x in the composition TiNₓ of titanium nitride becomes smaller, the golden color tone becomes weaker and, when the, value of atomicity x becomes larger, the color tone changes to dull and dark golden color. Accordingly, the value of atomicity x in TiNₓ is preferably 0.8 to 0.96. When the value of atomicity x is within this range, lustrous color tone is enhanced, so that golden color tone having higher high-grade impression and higher aesthetic satisfaction can be provided.

The values of lightness index L* and the chromaticness indices a* and b* in the L*a*b* color space of CIE1976 of the decorative surface can be measured in accordance with JIS Z 8722-2000. For example, a spectrocolorimeter (CM-3700d from Konica Minolta Holdings Inc. or a newer model) may be used in combination with CIE standard light source of D65 with view angle being set to 10 degrees, the measurement area set to 3 mm×5 mm and light spot area set to 5 mm×7 mm.

The ceramics for decorative part of the present invention preferably has Vickers hardness (Hv) of 8 GPa or higher on the decorative surface, since hardness of the decorative surface is one of factors that affect the reliability to provide high-grade impression, aesthetic satisfaction and mind soothing effect over a long period of time. When the surface has Vickers hardness (Hv) of 8 GPa or higher, the decorative surface is less likely to be impaired even when put into contact with hard substances such as dust formed from glass or metal. Vickers hardness (Hv) of the decorative surface can be measured in accordance with JIS R 1610-2003.

As details are described hereinafter, when a green compact is formed by the dry pressure molding method, Vickers hardness (Hv) of the decorative surface of 8 GPa or more can be achieved by setting the molding pressure in a range of 49 MPa or more and 196 MPa or less.

It is preferable that the ceramics for decorative part of the present invention has thermal conductivity in a range of 20 W/(m·K) or more and 26 W/(m·K) or less.

When thermal conductivity is 20 W/(m·K) or higher, better heat dissipation can be achieved so that it is made possible to quickly dissipating the heat generated by electronic parts such as insulated gate-bipolar-transistors (IGBT) that generate heat during operation to the outside, thereby reducing the possibility of malfunction of the electronic parts. Therefore, it is preferable to use the ceramics for decorative part of the present invention in part of a mobile terminal or the like having electronic parts packaged therein.

When thermal conductivity is 26 W/(m·K) or lower, dew condensation can be suppressed from occurring on the surface of the ceramics for decorative part of the present invention. Therefore, an emblem or other component of a vehicle comprising the ceramics for decorative part of the present invention hardly undergoes dew condensation and the resultant loss of aesthetic value even in the cold atmosphere of a morning in winter.

Furthermore, it is more preferred that thermal conductivity is in a range of 20 W/(m·K) or more and 26 W/(m·K) or less and also thermal expansion coefficient at 40° C. to 800° C. is 8.5×10⁻⁶/° C. or more and 9.7×10⁻⁶/° C. or less by the following reason. It is possible to provide with, in addition to the above heat dissipation, heat impact resistance. The thermal expansion coefficient can be determined in accordance with JIS R 1618-2002.

Although details are described hereinafter, grain growth during sintering is inhibited by controlling the firing temperature, at which a green compact is sintered, to between 1,600° C. or higher and 1,650° C. or lower, thus making it possible to control the thermal conductivity to 26 W/(m·K) or less. It is possible to control the thermal conductivity to 20 W/(m·K) or more by setting the total content of lithium, sodium, potassium, iron, calcium, magnesium, strontium, barium, manganese and boron that have the effect of decreasing thermal conductivity to 0.3% by mass or less.

It is also possible to control the thermal expansion coefficient to 8.5×10⁻⁶/° C. or more and 9.7×10⁻⁶/° C. or less.

### Manufacturing Method

The method of manufacturing ceramics for decorative part of the present invention will be described below.

In order to obtain ceramics for decorative part of the present invention, first, a powder of titanium nitride as the main component, a powder of unstabilized zirconia that does not substantially contain stabilizing agents such as yttrium oxide, magnesium oxide, calcium oxide, cerium oxide, neodymium oxide and dysprosium oxide, and powder of nickel are weighed in a predetermined amount and then mixed to obtain a prepared material.

More specifically, a titanium nitride powder having purity of 99% or more and a mean particle size that is more than that of unstabilized zirconia and 30 μm or less, an unstabilized zirconia powder having purity of 99% or more and a mean particle size of 1 μm or more and 2 μm or less, and a nickel powder having purity of 99.5% or more and a mean particle size of 5 μm or more and 20 μm or less may be prepared, weighed so that the content of unstabilized zirconia is 6% by mass or more and 30% by mass or less, the content of nickel is 3% by mass or more and 10% by mass or less and balance is titanium nitride, based on 100% by mass of all components that constitute ceramics for decorative part, and then mixed.

The titanium nitride powder may be composed of TiN with a stoichiometric composition or TiNₓ (0<x<1) with a non-stoichiometric composition. In order to obtain high-grade impression and aesthetic satisfaction, since it is preferred that the atomic number x preferably satisfies the inequality: 0.8≦x≦0.96 assumed that a composition formula of titanium nitride is TiNₓ, it is preferred to use a titanium nitride powder in which the value of the atomic number x satisfies the inequality: 0.7≦x≦0.9.

Next, nickel is added, followed by mixing, so as to bond crystal grains of titanium nitride

In order to increase fracture toughness by firmly bonding crystal grains of titanium nitride with each other, it is preferred to weigh and mix so that the contents of nickel becomes 4% by mass or more and 8% by mass or less based on 100% by mass of all components that constitute the ceramics for decorative part.

In order to improve corrosion resistance of ceramics for decorative part of the present invention, a chromium powder or a chromium carbide powder may be added so that the value obtained by converting the content of chromium to that of chromium carbide becomes 5% by mass or less based on 100% by mass of all components that constitute the ceramics for decorative part.

Next, an organic solvent such as 2-propanol(isopropyl alcohol) or methanol is added to the prepared material, followed by mixing and grinding using a mill. Thereafter, a predetermined amount of polyethylene glycol as a binder is added, followed by mixing, and the obtained slurry is dried by a spray drying method to obtain granules. The granules are filled in a predetermined molding die and then molded into a desired shape by desired molding means, for example, dry pressure molding method or cold isostatic pressure molding method to obtain a green compact. When the product has a complicated shape, a green compact may be obtained by a cast molding method or an injection molding method using a slurry prepared by adding a solvent, a binder or the like to a prepared material. It is also possible to obtain a green compact by molding into a block shape or a shape close to a shape of the product by various molding methods, followed by cutting.

When a dry pressure molding method is selected as the molding method of a green compact, since the molding pressure exerts an influence on the open porosity and Vickers hardness (Hv) in the decorative surface, it is preferable to set the molding pressure in the range of 49 MPa or more and 196 MPa or less. When the molding pressure is set to 49 MPa or more and 196 MPa or less, the service life of the molding die can be elongated and the open porosity of 3% or less can be achieved and the Vickers hardness (Hv) of 8 GPa or more can be achieved.

Next, if necessary, the obtained green compact is degreased in a non-oxidizing atmosphere such as nitrogen atmosphere or argon atmosphere. Then the obtained green compact is sintered by heating in at least one kind of a gas selected from nitrogen and inert gases, or in vacuum to obtain a sintered body.

The reason why the green compact is sintered by heating in at least one kind of a gas selected from nitrogen and inert gases, or in vacuum is as follows. That is, when the green compact is sintered by heating in the oxidizing atmosphere, titanium nitride is oxidized into titanium oxide and an influence of a white color tone peculiar to this titanium oxide is exerted, and thus the color tone of the entire ceramics for decorative part becomes dull color with white shade

The temperature at which the green compact is sintered by heating (firing temperature) exerts an influence on mechanical properties of ceramics for decorative part and open voids on the surface. In the case of low firing temperature, densification does not proceed and there arises a problem that open voids increase or mechanical properties may deteriorate. In contrast, in the case of high firing temperature, abnormal grain growth may generate and mechanical properties may deteriorate. From such a point of view, it is preferable that the firing temperature is controlled in a range of 1,550° C. or higher and 1,650° C. or lower.

Compression stress applied on crystals of titanium nitride in the sintered body varies depending on relative density of the sintered body, and increases as relative density becomes higher. In order to control the compression stress applied on crystals of titanium nitride to 350 MPa or more by increasing the relative density, the green compact obtained by the above method may be sintered at the firing temperature in a range of 1,600° C. or higher and 1,650° C. or lower.

In order to control the thermal conductivity of a titanium nitride-based sintered body, namely, ceramics for decorative part according to the present invention to 26 W/(m·K) or less, it is necessary to suppress grain growth. The grain growth is moderately suppressed by controlling the firing temperature within a range of 1,600° C. or higher and 1,650° C. or lower, and thus the thermal conductivity can be controlled to 26 W/(m·K) or less.

In order to control the thermal conductivity of a titanium nitride-based sintered body, namely, ceramics for decorative part according to the present invention to 20 W/(m·K) or more, the total contents of lithium, sodium, potassium, iron, calcium, magnesium, strontium, barium, manganese and boron, each having the effect of decreasing the thermal conductivity, may be controlled to 0.3% by mass or less based on the powder of titanium nitride.

As described above, by controlling the firing temperature and the total contents of lithium, sodium, potassium, iron, calcium, magnesium, strontium, barium, manganese and boron, it is possible to control the thermal conductivity of the ceramics for decorative part according to the present invention in a preferable range of 20 W/(m·K) or more and 26 W/(m·K) or less.

The sintered material thus obtained is polished as required, so as to control the lightness index L* in a range of 60 or more and 70 or less, chromaticness index a* in a range of 6.0 or more and 8.2 or less, and chromaticness index b* in a range of 16.5 or more and 24.5 or less in the L*a*b* color space of CIE1976 of the decorative surface of the ceramics for decorative part.

The sintered material having ring or cylindrical shape may be subjected to barrel polishing in a rotary barrel polisher, and the sintered material having plate shape such as disk may be subjected to lapping operation on the principal surface thereof by using a diamond paste, so that surface roughness falls within a range of 0.05 μm or more and 0.23 μm or less in terms of an arithmetic mean height Ra in either case. Barrel polishing and lapping operation may be combined, lustrous golden color tone can be obtained by subjecting to these polishing operations.

Moreover, other polishing method may be employed that can achieve arithmetic mean height Ra in a range of 0.05 μm or more to 0.23 μm and less.

The arithmetic mean height Ra may be measured in accordance to JIS B 0601-2001. Measurement length and the cut-off point (cut-off value) are set to 5 mm and 0.8 mm, respectively. When measuring with a contact probe type surface roughness meter, for example, a stylus (sensing needle) having tip radius of 2 μm may be put into contact with the decorative surface of the ceramics for decorative part, and scanned at a speed of 0.5 mm/sec. The arithmetic mean height Ra of the decorative surface is the average of values measured at 5 points.

The ceramics for decorative part of the present invention obtained by the above method has high wear resistance and golden color of satisfactory brightness and clearness, and therefore continuously produces high-grade impression, aesthetic satisfaction and mind soothing effect over a long period of time. As a result, if the ceramics for decorative part of the present invention is used in a decorative part for fish line guide, golden color tone can be maintained over a long period of time since the ceramics for decorative part has high wear resistance and is not likely to be damaged on the surface even when rubbed with fine sand particles that stick onto the fish line when it is guided. Moreover, the ceramics for decorative part of the present invention is capable of producing a golden color tone having high decorative value and constituting an attractive product that provides high-grade impression, and therefore the ceramics for decorative part can be preferably used as a decorative part of a watch such as a watch case and links of watchband, decorative parts of mobile terminal such as control keys of a mobile phone which are operated by pressing, a decorative part of an accessory such as a brooch, a necklace, an earring, a ring, a necktie pin, a tie tack, a medal, a button, etc., a decorative part for architectural members such as tiles for decorating floor, wall or ceiling, door handle, etc., a decorative part for kitchen utensil (a decorative part for daily life articles) such as a spoon, a fork or the like.

Wear resistance of the ceramics for decorative part of the present invention can be evaluated by assembling a wear resistance evaluation apparatus having such a constitution as described below and using it.

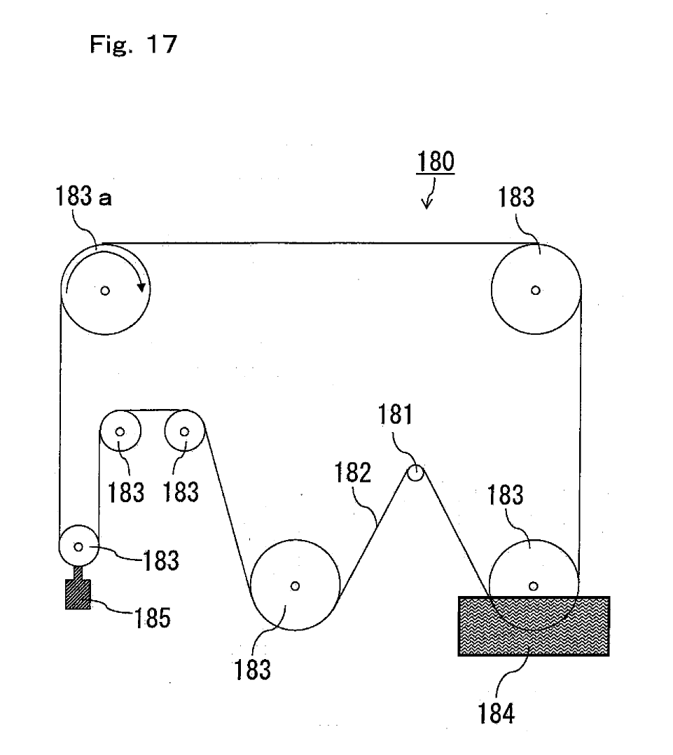

FIG. 17 is a schematic diagram showing the constitution of a wear resistance evaluation apparatus used to evaluate wear resistance of the ceramics for decorative part of the present invention. The wear resistance evaluation apparatus 180 comprises a nylon string 182, a plurality of pulleys 183 that apply tension to the nylon string 182 at a predetermined position, a motor (not shown) connected to one pulley 183a of the pulleys 183 for running the string 182 in the direction indicated by arrow, and a water tank 184 in which the string 182 is wetted with muddy water. The string 182 that is loaded with a weight 185 and has been wetted with muddy water while passing through the water tank 184 moves while rubbing against the circumferential surface of the ceramics for decorative part 181 of cylindrical shape which is secured at a predetermined position by a fixture (not shown). Count (defines the diameter) of the nylon string 182 may be, for example, No. 3.

When wear resistance of the ceramics for decorative part 181 is evaluated by using the wear resistance evaluation apparatus 180, such conditions may be employed as, for example, the weight 185 weighing 500 g is used, speed of the string 182 running along the circumferential surface of the ceramics for decorative part 181 of cylindrical shape may be set to 60 m/minute and traveling distance of the string 182 may be set to 3,000 m or more. After pulling the string 182 to run under the preset conditions with the motor, deepest dent caused in the ceramics for decorative part through friction with the string 182 is measured under a surface profile microscope (manufactured by Keyence Corp., with probe VF-7510 and controller VF-7500), and the measured values are compared to evaluate the wear resistance.

### 2. Decorative Parts Comprising the Ceramics for Decorative Part of the Present Invention

The ceramics for decorative part of the present invention has high wear resistance and golden color tone that provides high-grade impression, aesthetic satisfaction and mind soothing effect as described above. Thus the ceramics for decorative part of the present invention can be applied to various decorative parts such as decorative part for fish line guide, decorative part for watch, decorative part for mobile terminal, decorative part for accessory, decorative part for vehicle parts, decorative part for sports goods, decorative part for musical instrument and decorative part for daily life articles.

Decorative parts comprising the ceramics for decorative part of the present invention are also contained within the scope of the present patent application. Such decorative parts will be exemplified in detail below.

### Decorative Part for Fish Line Guide

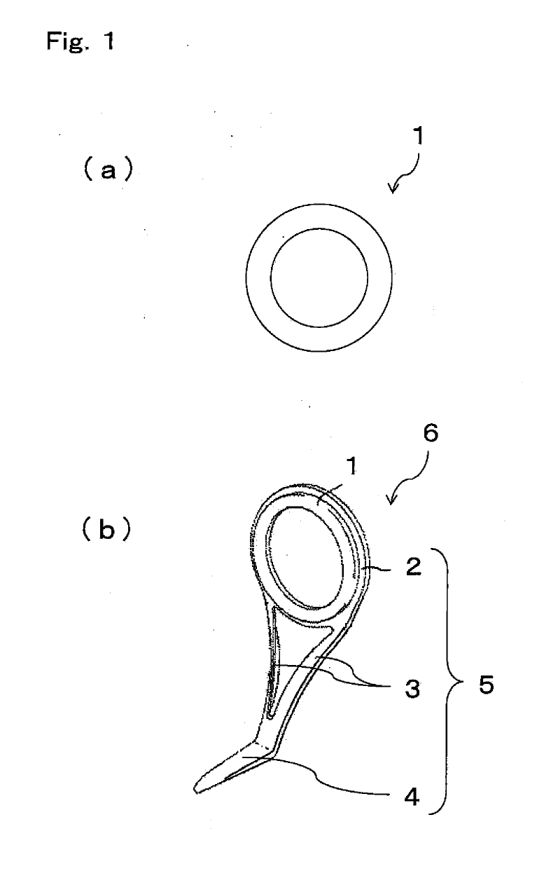

FIG. 1 shows a fish line (fishing line) guide ring that is a decorative part for fish line guide of the present invention, and an example of a fish line guide provided with the fish line guide ring, FIG. 1(a) is a plan view of the fish line guide ring, and FIG. 1(b) is a perspective view of a fish line guide having the fish line guide ring shown in FIG. 1(a).

The guide ring for fish line 1 is used to guide a fish line (not shown) inserted through the inside thereof. The fish line guide S comprises the fish line guide ring 1 and a holding section 2 that holds the fish line guide ring 1, wherein a support 3 of the holding section 2 and a mount 4 fastened onto a fishing rod (not shown) are integrally formed in a frame 5.

The fish line guide ring 1 comprises the ceramics for decorative part of the present invention. The fish line guide ring 1 has high wear resistance and is therefore not likely to be damaged on the surface even when rubbed with fine sand particles that stick onto the fish line when it is guided therein, so that it is capable of maintaining the golden color over a long period of time.

The fish line guide ring 1 may be coated on the surface thereof with a transparent film having high wear resistance such as hard amorphous carbon, so as to improve the wear resistance further. In this case, the use of the transparent film enables it to see the golden color of the ceramics for decorative part of the present invention.

### Decorative Part for Watch

Examples of the decorative parts for watch composed of the ceramics for decorative part of the present invention include watch case and links of watch band.

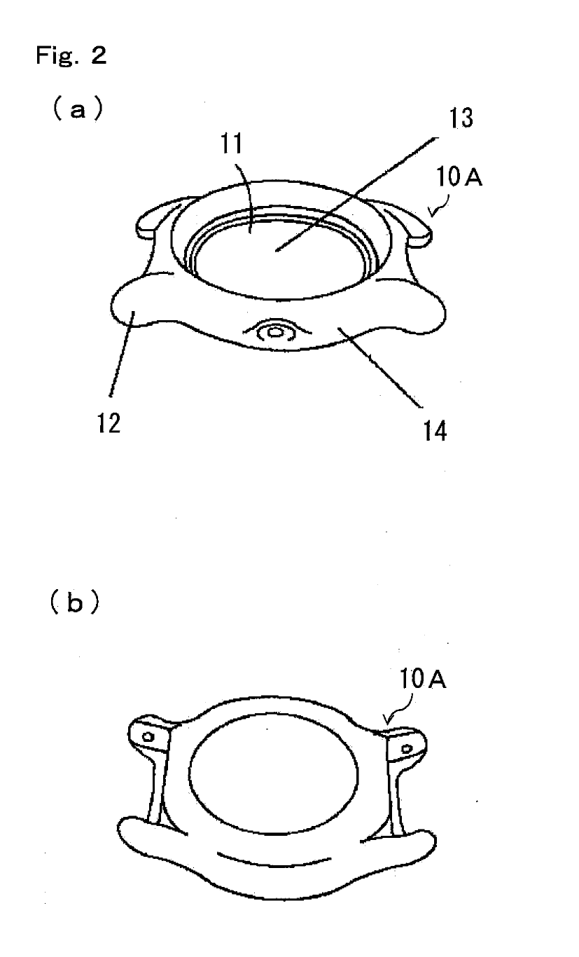

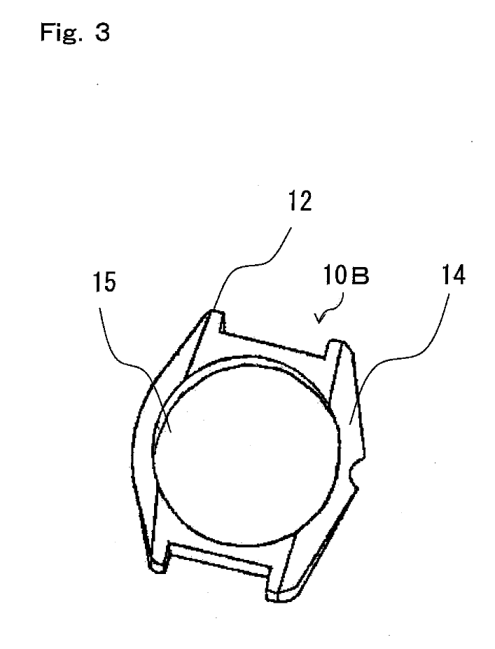

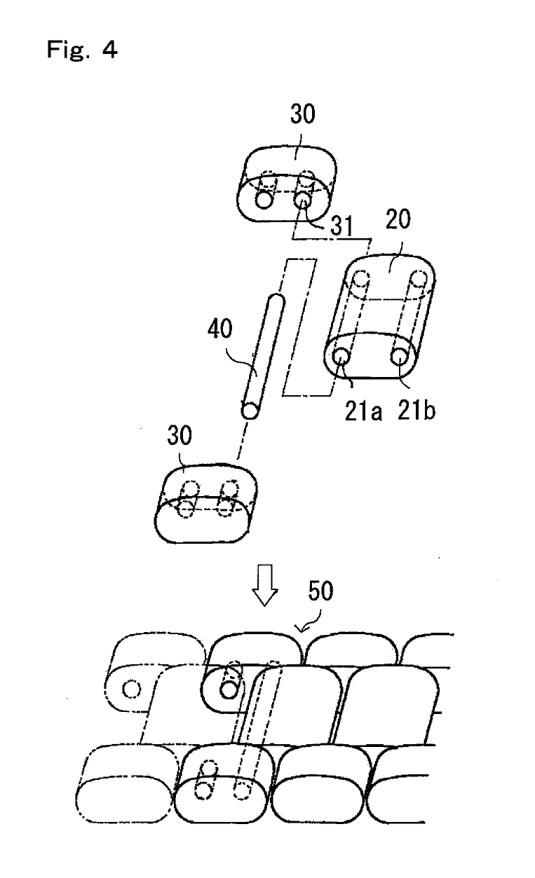

FIG. 2 shows an example of a watch case which is a decorative part for watch of the present invention, FIG. 2(a) is a perspective view of the watch case as seen from the front surface, and FIG. 2(b) is a perspective view of the watch case of FIG. 2(a) as seen from the back surface. FIG. 3 is a perspective view showing another example of a watch case which is a decorative part for watch of the present invention. FIG. 4 is a schematic diagram showing an example of constitution of a watchband as an application of a decorative part of watch of the present invention. Identical members are denoted with the same reference numeral in these drawings.

The watch case 10A shown in FIG. 2(a) and FIG. 2(b) has a recess 11 that houses a movement (drive mechanism) (not shown), and protrusions 12 which engage a watchband (not shown) for wearing the watch on a wrist, wherein the recess 11 is constituted from a thin bottom 13 and a thick wall 14. The watch case 10B shown in FIG. 3 has a hole 15 which accommodates a movement (drive mechanism) which is not shown, and protrusions 12 provided on the wall 14 for engaging a watchband (not shown) so as to wear the watch on a wrist.

The links that constitute the watchband 50 shown in FIG. 4 include inner links 20 each having a through hole 21 into which a pin 40 is inserted and outer links 30 which are disposed to sandwich the inner link 20 and each having pin holes 31 in which the both ends of the pin 40 are inserted. The inner link 20 and the outer links 30 are linked with each other by inserting the pin 40 into the through hole 21 of the inner link 20, and engaging both ends of the inserted pin 40 in the pin holes 31 of the outer links 30, thereby to assemble the watchband 50.

The decorative parts for watch of the present invention that include the watch cases 10A, 10B and the links (the inner link 20 and the outer links 30) that constitute the watchband 50 are formed from the ceramics for decorative part of the present invention, and therefore have golden color tone of high aesthetic value and high wear resistance, so as to provide the user with high-grade impression, aesthetic satisfaction and mind soothing effect through visual sense over a long period time.

### Decorative Parts for Mobile Terminal

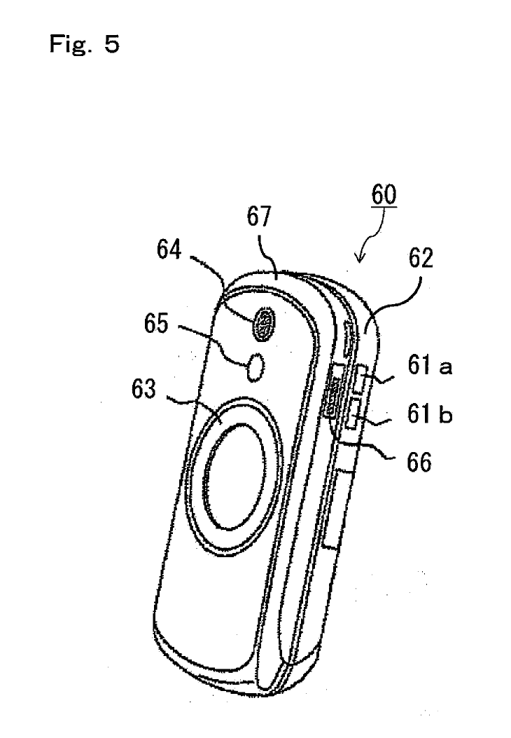

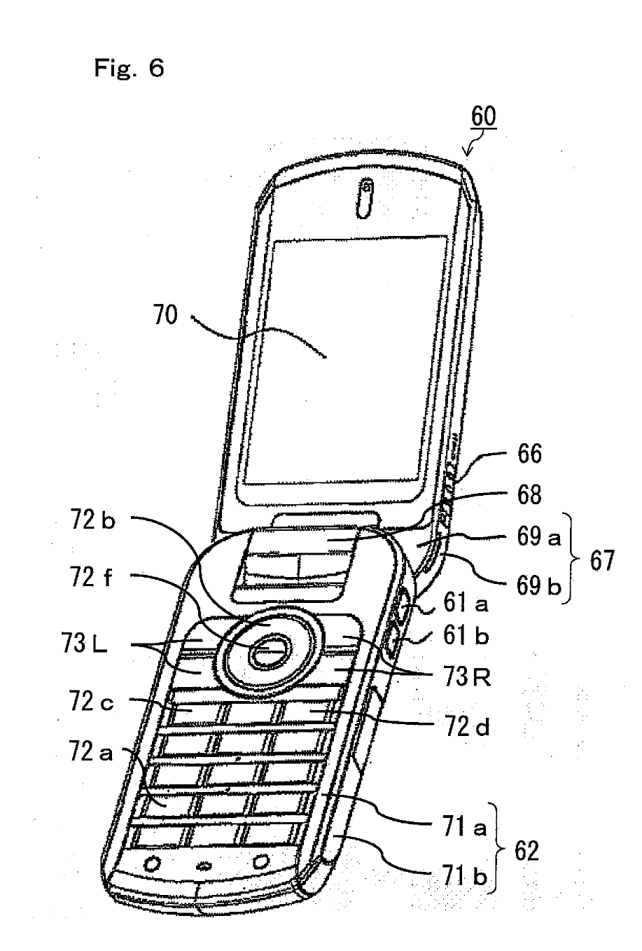

FIG. 5 is a perspective view showing an example of a mobile phone that uses a decorative part for mobile terminal of the present invention. FIG. 6 is a perspective view showing the mobile phone of the example shown in FIG. 5 in a state of chassis opened.

Specific examples of decorative parts for mobile terminal composed of the ceramics for decorative part of the present invention include control keys, case, switches, etc. shown in FIG. 5 and FIG. 6 which will be described below.

The mobile phone 60 of the example shown in FIG. 5 has a mode key 61a for changing the operation mode of the mobile phone 60 between radio mode for listening to radio broadcast, music mode for listening to music and the like, and a silencer key 61b for putting the mobile phone 60 into silent mode, both keys being provided on a first chassis 62, and has a touch sensor 63 for entering commands by touching a finger or other object thereon, a camera 64 for capturing an image, a light 65 and a slide switch 66 for enabling or disabling the entry through the touch sensor 63, which are provided on a second chassis 67.

FIG. 6 shows the state where the second chassis 67 is opened in the mobile phone 60. The first chassis 62 and the second chassis 67 are linked to each other via a hinge 68, so that the second chassis 67 can be freely opened. The second chassis 67 has a front case 69a and a rear case 69b, while a liquid crystal display 70 is provided on the front case 69a.

The first chassis 62 also has a front case 71a and a rear case 71b, while various control keys are provided on the front case 71a. The control keys include numeral keys 72a for entering telephone numbers and the like, cursor keys 72b for moving the cursor over a menu of various functions, a talk key 72c to be pressed to start talking when receiving a call, a power/hang up key 72d for turning the power on or off and hanging up the line to end talking, function keys 73L, 73R, etc. disposed on the left and right sides of a center key 72f which is disposed at the center of the cursor key 72b.

When at least one kind of the front cases 69a and 71a, the rear cases 69b and 71b, the numeral keys 72a, the cursor keys 72b, the talk key 72c, the power/hang up key 72d, the center key 72f, the function keys 73L, 73R, etc. is formed from the ceramics for decorative part of the present invention, high-grade impression, aesthetic satisfaction and mind soothing effect are provided to the user over a long period of time, while allowing the user to have satisfying feeling of owning the mobile phone of such a color tone. Also because the ceramics for decorative part of the present invention has favorable property for color coordination, it is capable of satisfying the requirements of diverse users by combining with members of various color tones.

While the mobile phone has been described as one example of mobile terminals, the mobile terminal, to which the decorative part of the present invention can be applied, is not limited to the mobile phone. The present invention can also be applied to various portable information terminals of which parts are required to have decorative value, such as portable information terminal (PDA), portable navigation system and portable audio player.

### Decorative Part for Daily Life Articles

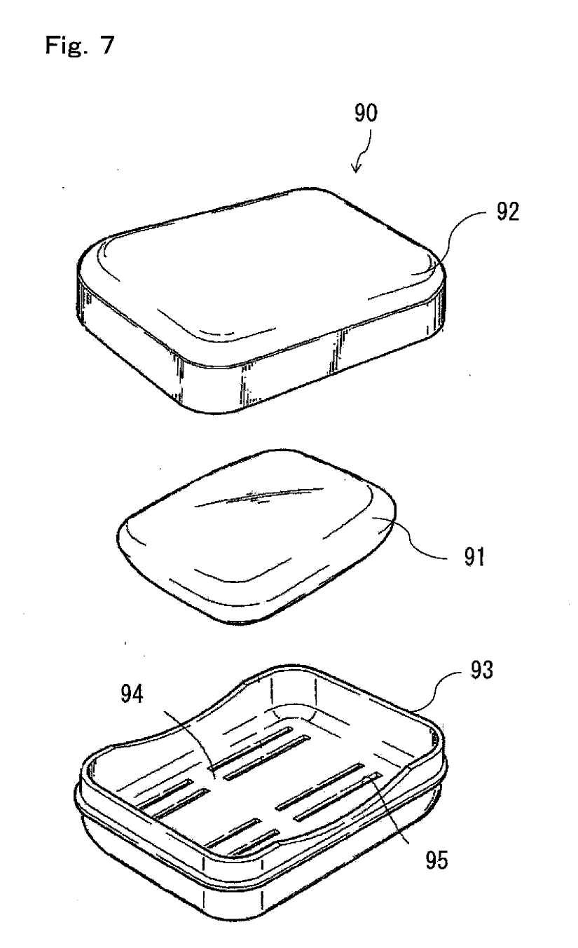

FIG. 7 is a schematic diagram showing an example of constitution of a soap case as an application of a decorative part for daily life articles of the present invention.

The soap case 90 is composed of a case body 93 and a cap 92, wherein a soap placing surface 94 of the case body 93 whereon a piece of soap 91 is to be placed has draining slits 95 for draining water carried by the soap 91 formed therein. When the soap 91 is not used, the soap 91 is placed on the soap placing surface 94, and the cap 92 is put onto the case body 93. When the soap 91 is used, the cap 92 is removed from the case body 93 and the soap 91 is taken out. By placing the soap 91 on the soap placing surface 94 after use, water carried by the soap 91 can be drained through the drain slits 95, so as to prevent the soap 91 from being soaked with water.

By forming the cap 92 and/or the case body 93 of the soap case 90 from the ceramics for decorative part of the present invention, it is made possible to provide many users with the joy of possessing it and gives high-grade impression, aesthetic satisfaction and mind soothing effect through visual sense.

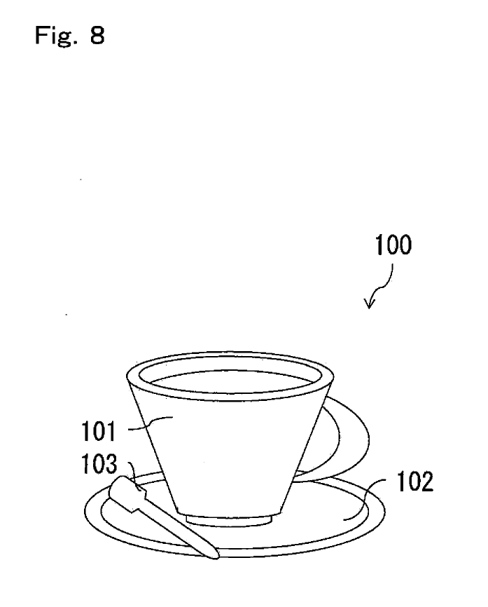

FIG. 8 is a perspective view showing an example of a coffee cup set as another application of a decorative part for daily life articles of the present invention.

The coffee cup set 100 shown in FIG. 8 comprises a coffee cup 101, a saucer 102 and a spoon 103. By forming the coffee cup 101, the saucer 102 and the spoon 103 from the ceramics for decorative part of the present invention, it is made possible to provide many users with the joy of possessing it and gives high-grade impression, aesthetic satisfaction and mind soothing effect through visual sense during use.

Since the ceramics for decorative part of the present invention has favorable property for color coordination, at least one of the coffee cup 101, the saucer 102 and the spoon 103 may be formed from the ceramics for decorative part of the present invention while combining with other members having different color tones.

Applications of the decorative part for daily life articles of the present invention are not limited to the soap case 90 and the coffee cup set 100, and can also be applied to the handle of tooth brush or shaver, earpick, scissors and other decorative parts for daily life articles. By furnishing the bath rooms and toilet rooms of a luxury hotel with toiletry goods comprising the ceramics for decorative part of the present invention and marked with logos or the like, it is made possible to provide high-grade impression, aesthetic satisfaction and mind soothing effect, spiced with excitement of being cutoff from the everyday lives.

### Decorative Part for Vehicle Parts

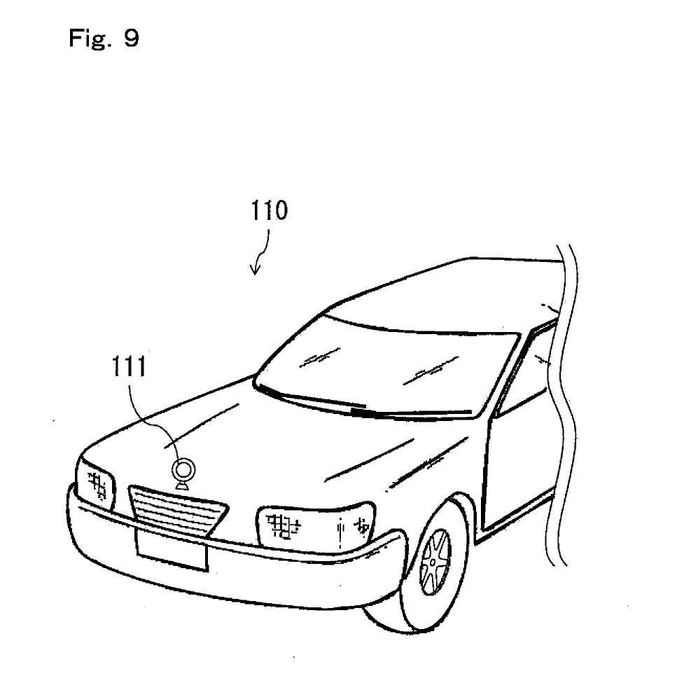

FIG. 9 is a perspective view showing an example of a vehicle body having a decorative part for vehicle parts of the present invention mounted thereon.

The vehicle body 110 shown in FIG. 9 has an emblem 111 which is an example of the decorative part for vehicle parts. By forming the emblem 111 from the ceramics for decorative part of the present invention, it is made possible to provide the user with high-grade impression, aesthetic satisfaction and mind soothing effect through visual sense, and improve the decorative value of the vehicle body 110.

While FIG. 8 shows the emblem 111 that is mounted on the front of the vehicle body 110, decorative value of the vehicle body 110 can be improved also by attaching the emblem 111 formed from the ceramics for decorative part of the present invention that shows the manufacturer's name or the model name, on the rear of the vehicle body 110.

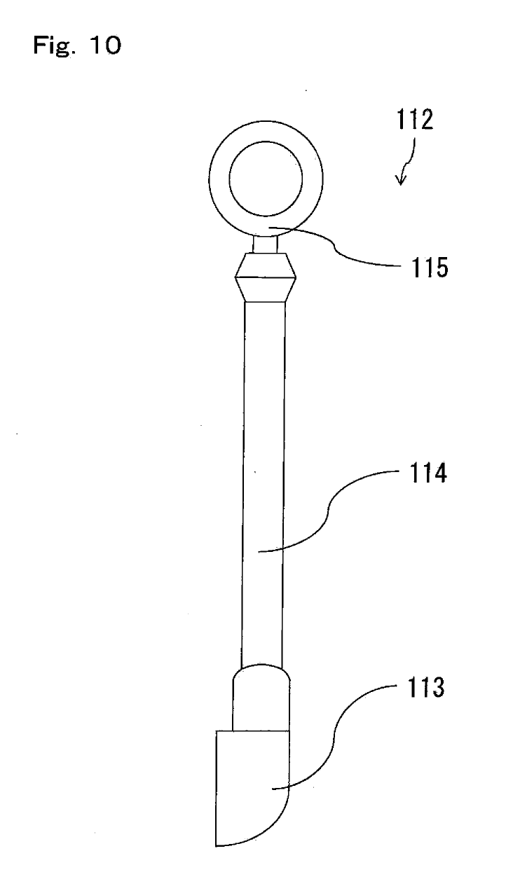

FIG. 10 is a front view showing an example of a corner pole that uses a decorative part for vehicle parts of the present invention.

The corner pole 112 shown in FIG. 10 is installed so as to mark the left front corner of the vehicle (in the case of a right-hand drive vehicle) which is difficult to see from the driver seat when moving in or out of a parking lot, and comprises a mount 113 to be fastened onto the vehicle body, a pole 114 and a lighting unit 115 consisting of LED or the like. It is advantageous to form the pole 114 of the corner pole 112 from the ceramics for decorative part of the present invention, or mounting the emblem formed from the ceramics for decorative part of the present invention instead of the lighting unit 115, so as to improve decorative value of the vehicle body as well as that of the corner pole 112.

In addition to the emblem 111 and the corner pole 112, the decorative part for vehicle parts of the present invention may be applied to a part of wheel cap, a part of hood ornament mounted on the bonnet of the vehicle body, small articles and accessories installed in the passenger room of the vehicle or a part thereof, with favorable effect of improving the decorative value.

### Decorative Part for Sports Goods

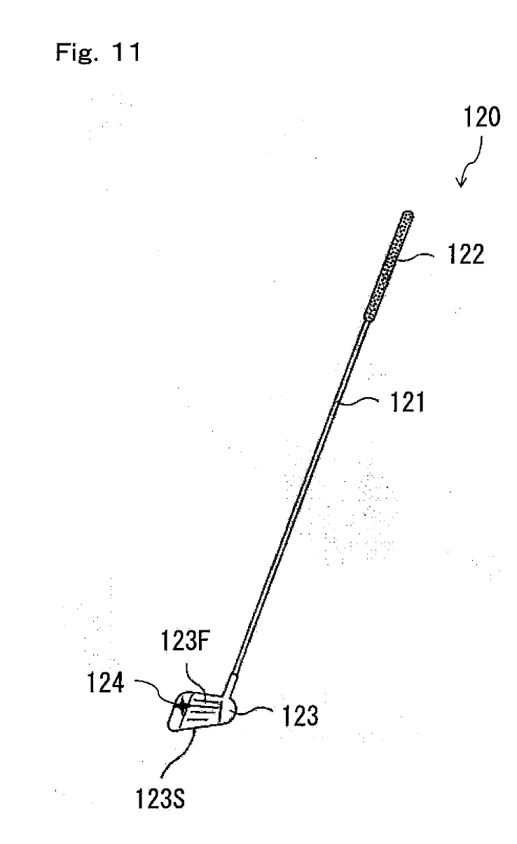

FIG. 11 is a front view showing an example of a golf club that uses a decorative part for sports goods of the present invention.

The golf club 120 shown in FIG. 11 has a shaft 121, a grip 122 attached to one end of the shaft 121 and a head 123 attached to the other end of the shaft 121. The head 123 has an face 123F that hits a golf ball, and a sole surface 123S that touches the ground. An accessory 124 formed from the ceramics for decorative part of the present invention is embed in the face 123F, as shown in FIG. 11, which improves the decorative value.

In addition to the face 123F, the accessory 124 formed from the ceramics for decorative part of the present invention may also be preferably embedded in the sole surface 123S or the grip 122.

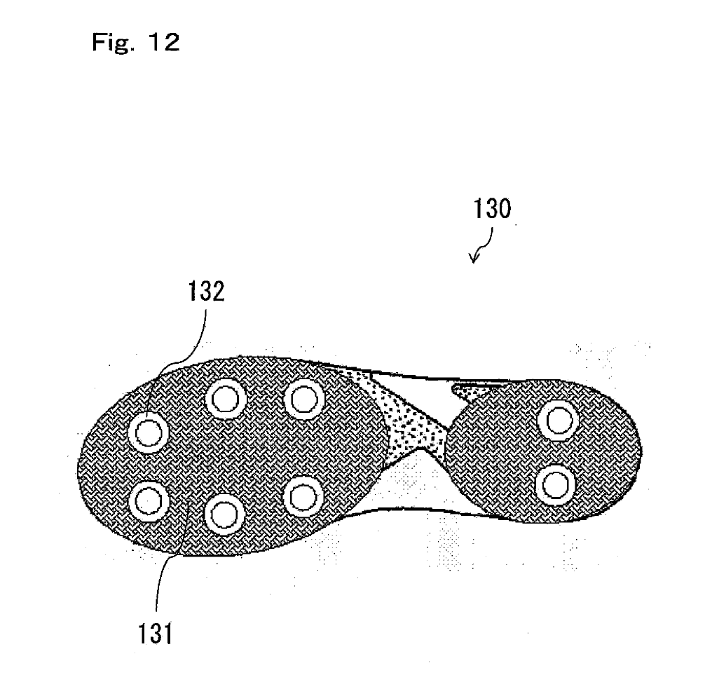

FIG. 12 is a bottom view showing an example of spike shoes that use a decorative part for sports goods of the present invention.

The spike shoes 130 shown, in FIG. 12 are worn by, for example, soccer or rugby players, and has a plurality of studs 132 planted in a sole 131 to protrude therefrom so as to stabilize a pivot foot when kicking a ball. Forming the studs 132 from the ceramics for decorative part of the present invention improves the decorative value of the spike shoes 130. Moreover, since it has higher wear resistance than that of conventional studs made of aluminum alloy, it is made possible to decrease the frequency of replacement of the studs 132 and thereby reducing the cost incurred from the replacement. The studs 132 may be covered by a transparent resin to prevent the studs 132 from being chipped during a game.

### Decorative Part for Musical Instrument

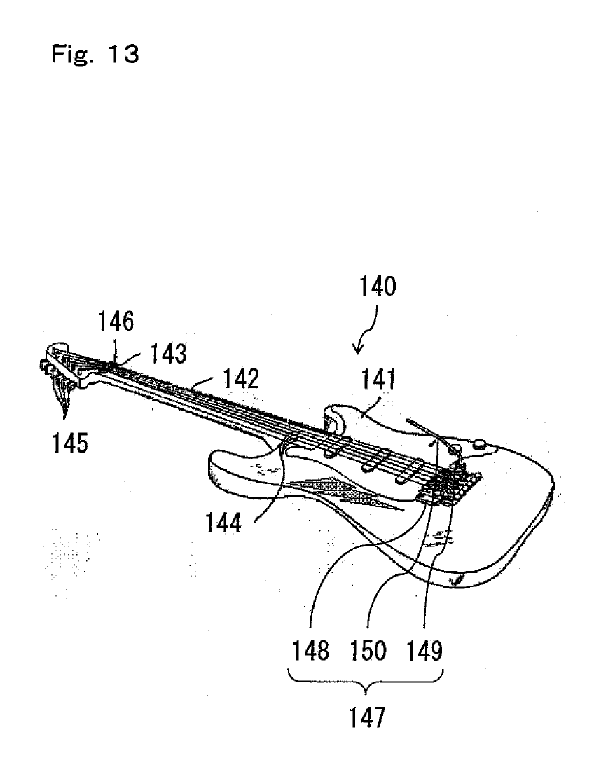

FIG. 13 is a perspective view showing an example of a guitar that uses a decorative part for musical instrument of the present invention.

The guitar 140 shown in FIG. 13 consists mainly of a body 141 and a neck 142 that extends from the body 141 toward the distal end. Disposed near the distal end of the neck 142 is a nut 143, and a tuning peg 145 is provided beyond the nut 143 for each of strings 144 for adjusting the tension of the string 144. A clamp mechanism 146 is provided near the nut 143 so as to hold the strings 144 stationary with respect to the nut 143.

The body 141 has a tremolo arm 147 for producing sound effect by increasing or decreasing the tensions of the strings 144 at the same time. The tremolo arm 147 comprises a base plate 148 that is attached to the body 141, a bridge saddle 149 that is held on the base plate 148 and holds the strings 144 in tunable state, and a tremolo bar 150 that actuates the tremolo arm.

By forming one or more of constituent elements of the guitar 140, such as the base plate 148, the bridge saddle 149 and the tremolo bar 150 of the guitar 140 from the ceramics for decorative part of the present invention, it is made possible to improve the decorative value of the guitar 140. This provides the joy of possessing the guitar 140 and helps captivate a large audience.

### Decorative Part for Accessory

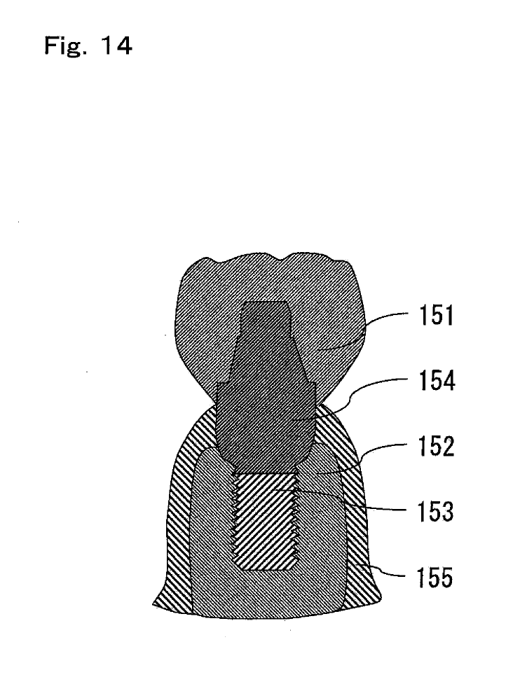

FIG. 14 is a schematic sectional view showing an example of an artificial dental crown that uses a decorative part for accessory of the present invention. FIG. 14 shows an artificial dental root (implant) 153 which is embedded in a jaw bone 152 within a gingival 155, an abutment 154 fastened onto the artificial dental root 153 and an artificial dental crown 151 installed on the abutment 154.

When the artificial dental crown 151 is formed from the ceramics for decorative part of the present invention, the tooth shines in golden color which gives enthusiastic feeling to users who like decorating their teeth.

The side face of the artificial dental root 153 embedded in the jaw bone 152 may be formed in the shape of screw. A hard bond layer may be formed, on the portion that is formed in the shape of screw, from a biodegradable material that contains at least one kind selected from among chitin, collagen and derivatives thereof that have capability to induce the generation of new bone. Base of the abutment 154 may have a soft bond layer formed from the biodegradable material described above that is cross-linked, so as to make contact with the gingival 155 located over the jaw bone 152.

The ceramics for decorative part of the present invention is formed from titanium nitride-based sintered material, and is therefore biocompatible. It is preferable to make use of this advantage through application to the artificial dental root 153 and the abutment 154, as well as the artificial dental crown 151.

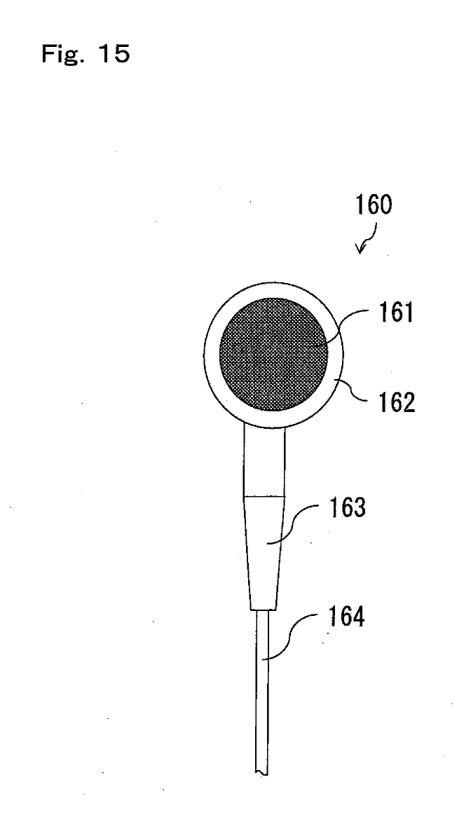

FIG. 15 is a front view showing an example of an earphone unit that uses a decorative part for accessory of the present invention.

The earphone unit 160 shown in FIG. 15 comprises a speaker 161 that is inserted into the ear of the listener to produce sound waves, a case 162 that houses the speaker 161 and a cord 164 that feeds electric signals to the speaker 161 via a lead 163 that is in contact with the case 162.

By forming the case 162 of the earphone unit 160 from the ceramics for decorative part of the present invention, it is made possible to provide the decorative part for accessory that improves the decorative value, and provides many users with high-grade impression, aesthetic satisfaction and mind soothing effect through visual sense.

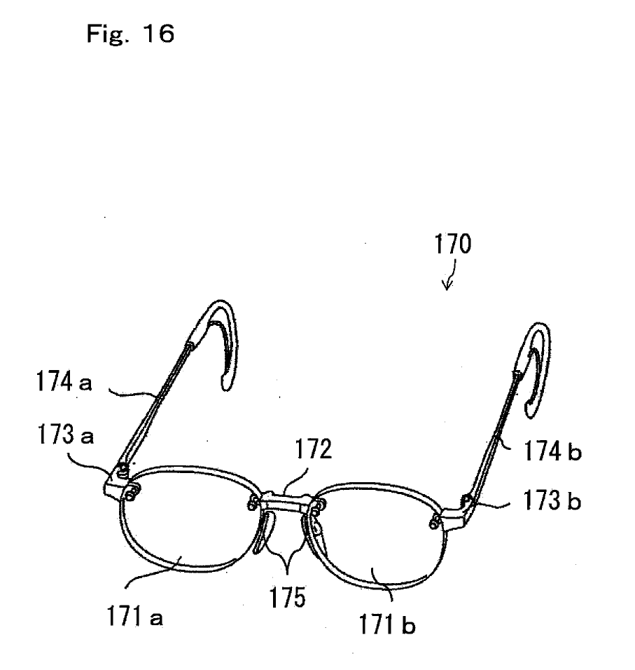

FIG. 16 is a perspective view showing an example of an eyeglass that uses a decorative part for accessory of the present invention.

The eyeglasses 170 shown in FIG. 16 comprise a pair of lenses 171a, 171b that provide vision correction or protection of eyes against ultraviolet rays, a bridge 172 that links the pair of lenses 171a, 171b together, lugs (end pieces) 173a, 173b that connect to the respective lenses 171a, 171b, temples 174a, 174b that are pivotally connected via respective hinges to the lugs 173a, 173b, and a nose pad 175 attached via nose pad link members to the lenses 171a, 171b, respectively.

By forming at least one of the bridge 172, the temples 174a, 174b and the nose pad 175 of the eyeglasses 170 from the ceramics for decorative part of the present invention, it is made possible to provide the decorative part for accessory that improves the decorative value, and provides many users with high-grade impression, aesthetic satisfaction and mind soothing effect through visual sense.

### EXAMPLES

Examples of the present invention will be specifically described, but the present invention is not limited to the following Examples.

### Example 1

A titanium nitride powder having purity and a mean particle size as shown in Table 1, a zirconia powder containing no stabilizing agent and a nickel powder were weighed so that the obtained ceramics for decorative part has contents of unstabilized zirconia and nickel as shown in Table 2, and then mixed to obtain a prepared material.

TABLE 1

| | Raw Material | | | | | | |
|---|---|---|---|---|---|---|---|
| | Titanium Nitride | | Zirconia Powder Containing | | | | |
| | Powder | | no Stabilizing Agent | | Nickel Powder | | Firing |
| Specimen | Purity | Mean Particle | Purity | Mean Particle | Purity | Mean Particle | Temperature |
| No. | (%) | Size (μm) | (%) | Size (μm) | (%) | Size (μm) | (° C.) |
| *1 | 99 | 12.8 | 99 | 1.5 | 99.5 | 12 | 1610 |
| 2 | 99 | 2.6 | 99 | 1.5 | 99.5 | 12 | 1610 |
| 3 | 99 | 2.5 | 99 | 1.5 | 99.5 | 12 | 1610 |
| 4 | 99 | 2.5 | 99 | 1.5 | 99.5 | 12 | 1610 |
| 5 | 99 | 3.0 | 99 | 1.5 | 99.5 | 12 | 1610 |
| 6 | 99 | 3.0 | 99 | 1.5 | 99.5 | 12 | 1610 |
| 7 | 99 | 3.0 | 99 | 1.5 | 99.5 | 12 | 1610 |
| 8 | 99 | 3.0 | 99 | 1.5 | 99.5 | 12 | 1610 |
| 9 | 99 | 3.0 | 99 | 1.5 | 99.5 | 12 | 1610 |
| 10 | 99 | 3.0 | 99.9 | 1.5 | 99.5 | 12 | 1610 |
| 11 | 99 | 3.2 | 99 | 1.5 | 99.5 | 12 | 1610 |
| 12 | 99 | 3.8 | 99 | 1.5 | 99.5 | 12 | 1610 |
| 13 | 99 | 5.3 | 99 | 1.5 | 99.5 | 12 | 1610 |
| 14 | 99 | 7.5 | 99 | 1.5 | 99.5 | 12 | 1610 |
| 15 | 99 | 12.0 | 99 | 1.5 | 99.5 | 12 | 1610 |
| 16 | 99 | 15.8 | 99 | 1.5 | 99.5 | 12 | 1610 |
| 17 | 99 | 10.5 | 99 | 1.5 | 99.5 | 12 | 1610 |
| 18 | 99 | 18.8 | 99 | 1.5 | 99.5 | 12 | 1610 |
| 19 | 99 | 10.5 | 99 | 1.5 | 99.5 | 12 | 1550 |
| 20 | 99 | 10.5 | 99 | 1.5 | 99.5 | 12 | 1600 |
| 21 | 99 | 10.5 | 99 | 1.5 | 99.5 | 12 | 1650 |
| *22 | 99 | 12.0 | 99 | 1.5 | 99.5 | 12 | 1610 |
| *23 | 99 | 0.8 | 99 | 1.5 | 99.5 | 12 | 1610 |

*means a specimen not falling into the scope of the present invention.

Next, methanol as a solvent was added to each prepared material, followed by mixing and grinding for 120 hours in a vibration mill. A binder (3% by mass) such as polyethylene glycol was added to the prepared material, followed by mixing. The obtained slurry was dried by a spray drying method to obtain granules. The obtained granules were formed into a columnar green compact under a pressure of 98 MPa. Next, the obtained green compact was degreased in a nitrogen atmosphere at 600° C. and then allowed to stand in a nitrogen atmosphere at the firing temperature shown in Table 1 for 2 hours to obtain a columnar sintered body measuring 8 mm in diameter and 15 mm in length.

Using a rotary barrel polisher (barrel finishing machine), the obtained columnar sintered body subjected to barrel polishing to obtain specimens Nos. 1 to 23 of ceramics for decorative part having an arithmetic mean height Ra defined in JIS B 0601-20001 in a range of 0.05 to 0.23 μm.

The content of the unstabilized zirconia in the ceramics for decorative part of each specimen was determined as follows.

(111) and (11-1) reflection peak intensities of monoclinic crystal and (111) reflection peak intensities of tetragonal and cubic crystal measured by X-ray diffraction were used to calculate the ratio Xm of unstabilized zirconia to the content of total zirconia by the formula (1) described above.

The content of element zirconium (Zr) was measured by the ICP emission spectrometry analysis. The content of element zirconium was converted to the weight of oxide (zirconia), so as to determine the total zirconia content. The ratio Xm of unstabilized zirconia and the total zirconia content thus obtained were used to determine the content of unstabilized zirconia by the formula (2) described above.

Nickel content was also determined by the ICP emission spectrometry analysis.

The mean size of crystal grains of unstabilized zirconia and mean size of crystal grains of titanium nitride were determined by analyzing image obtained under a scanning electron microscope (SEM) with a magnification of 6,000 times. A ratio of the crystal grain size of unstabilized zirconia to the crystal grain size of titanium nitride was determined by dividing the mean size of the crystal grains of unstabilized zirconia by the mean size of the crystal grains of titanium nitride.

Compressive stress applied to the titanium nitride crystal was determined by measuring the compressive stress on the top surface of specimens Nos. 1 to 23 of ceramics for decorative part having cylindrical shape, with 2D method using an X-ray diffractometer (D8 DISCOVER with GADDS Super Speed manufactured by Broker AXS K.K.).

Wear resistance was evaluated by using the above wear resistance evaluation apparatus shown in FIG. 17. After fastening specimen Nos. 1 to 19 of ceramics for decorative part having cylindrical shape onto a predetermined position (position of ceramics for decorative part 101 in FIG. 17) with a fixture, 10 g of semi-porcelain clay (clay mixed with porcelain clay (kaolin)) was charged per 0.001 m³ of water to prepare muddy water in the water tank 104. The weight 105 weighing 500 g was used and speed of the nylon string 102 (Ginrin Σ No. 3 manufactured by Toray Inc.) was set to 60 m/minute and was caused to travel over a distance of 3,000 m. The string 102 wetted by the muddy water was pulled while rubbing against the circumferential surface of the ceramics for decorative part having cylindrical shape. Then the deepest dent caused in the surface of the ceramics for decorative part by abrasions with the string 102 was measured under a surface profile microscope (manufactured by Keyence Corp., with probe VF-7510 and controller VF-7500).

The fracture toughness K_{1C} was determined in accordance to indentation-fracture method (IF method) specified in JIS R 1607-1995. Color tone and cracks were evaluated by visual observation. Color tone was rated as “◯” when it was golden, golden color having shade of silver was rated as “Δ” and dull golden color with white shade was rated as “X”. Specimen with no cracks observed was rated as “◯”, and specimen with cracks observed was rated as “X”. The results are shown in Table 2.

TABLE 2

| | | | Crystal Grains | Crystal Grains of | | | | | | |
|---|---|---|---|---|---|---|---|---|---|---|
| | | | of Titanium | Unstabilized | | | | Rupture | | |
| | Unstabilized | Nickel | Nitride | Zirconia | | Compression | Worn-out | Toughness | Color | |
| Specimen | Zirconia | (% by | x | y | | Stress | Dept | K_{1c} | Tone | Crack |
| No. | (% by mass) | mass) | (μm) | (μm) | y/x | (MPa) | (μm) | (MPa · m^{1/2}) | Evaluation | Evaluation |
| *1 | 5 | 6 | 1.7 | 0.2 | 0.12 | 560 | 5.0 | 6.5 | ∘ | ∘ |
| 2 | 6 | 6 | 0.3 | 0.2 | 0.59 | 545 | 3.4 | 6.5 | ∘ | ∘ |
| 3 | 6 | 2 | 0.3 | 0.2 | 0.61 | 576 | 3.2 | 5.6 | ∘ | ∘ |
| 4 | 6 | 4 | 0.3 | 0.2 | 0.63 | 568 | 3.2 | 6.3 | ∘ | ∘ |
| 5 | 6 | 2 | 0.4 | 0.2 | 0.50 | 574 | 2.4 | 6.0 | ∘ | ∘ |
| 6 | 6 | 4 | 0.4 | 0.2 | 0.50 | 572 | 2.3 | 6.4 | ∘ | ∘ |
| 7 | 6 | 6 | 0.4 | 0.2 | 0.50 | 586 | 2.2 | 6.5 | ∘ | ∘ |
| 8 | 6 | 8 | 0.4 | 0.2 | 0.50 | 576 | 2.0 | 6.8 | ∘ | ∘ |
| 9 | 6 | 10 | 0.4 | 0.2 | 0.50 | 575 | 2.1 | 7.0 | Δ | ∘ |
| 10 | 6 | 6 | 0.4 | 0.2 | 0.50 | 570 | 2.1 | 7.0 | ∘ | ∘ |
| 11 | 6 | 6 | 0.4 | 0.2 | 0.50 | 569 | 2.2 | 6.5 | ∘ | ∘ |
| 12 | 6 | 6 | 0.5 | 0.2 | 0.40 | 580 | 2.2 | 6.6 | ∘ | ∘ |
| 13 | 6 | 6 | 0.7 | 0.2 | 0.29 | 581 | 2.1 | 6.6 | ∘ | ∘ |
| 14 | 6 | 6 | 1.0 | 0.2 | 0.20 | 582 | 2.1 | 6.6 | ∘ | ∘ |
| 15 | 11 | 6 | 1.8 | 0.2 | 0.13 | 572 | 2.1 | 6.6 | ∘ | ∘ |
| 16 | 16 | 6 | 2.1 | 0.2 | 0.10 | 577 | 2.0 | 6.6 | ∘ | ∘ |
| 17 | 22 | 6 | 2.1 | 0.3 | 0.14 | 573 | 2.0 | 6.6 | ∘ | ∘ |
| 18 | 27 | 6 | 2.5 | 0.2 | 0.08 | 562 | 3.3 | 6.5 | ∘ | ∘ |
| 19 | 30 | 6 | 2.1 | 0.3 | 0.14 | 320 | 2.2 | 6.6 | ∘ | ∘ |
| 20 | 30 | 6 | 2.1 | 0.3 | 0.14 | 350 | 1.8 | 6.6 | ∘ | ∘ |
| 21 | 30 | 6 | 2.1 | 0.3 | 0.14 | 603 | 1.4 | 6.6 | ∘ | ∘ |
| *22 | 31 | 6 | 2.4 | 0.3 | 0.13 | 678 | — | 5.8 | ∘ | x |
| *23 | 10 | 6 | 1.0 | 1.8 | 1.80 | 580 | 2.0 | 6.4 | x | ∘ |

*means a specimen not falling into the scope of the present invention.

As shown in Table 1 and Table 2, specimen No. 1 having content of unstabilized zirconia less than 6% by mass showed larger worn-out depth compared to other specimens. Indicating that specimen No. 1 had lower wear resistance than the other specimens. In specimen No. 22 having content of unstabilized zirconia more than 30% by mass, crack occurred because the material could not endure excessive compressive stress generated by volume expansion of the unstabilized zirconia when it was cooled down. In specimen No. 23 where crystal grain size of unstabilized zirconia was larger than the crystal grain size of titanium nitride, the color was influenced by the white color of unstabilized zirconia thus showing dull whitish color tone, although worn-out depth was small indicating high wear resistance

In specimens Nos. 2 to 21 of the present invention that contained titanium nitride as the main component, 6% by mass or more and 30% by mass or less of unstabilized zirconia that does not substantially contain a stabilizing agent, and nickel, the crystal grain size of unstabilized zirconia was smaller than the crystal grain size of titanium nitride. As a result, a high compressive stress was applied to the crystal grains of titanium nitride as the unstabilized zirconia underwent volume expansion when the ceramics was cooled down to the room temperature after being heated to a high temperature and sintered. Since crystal grains of titanium nitride under the high compressive stress did not easily come off, worn-out depth was as small as 3.4 μm or less, indicating high wear resistance and showed golden color tone that provided high-grade impression, aesthetic satisfaction and mind soothing effect.

In specimens Nos. 5 to 17 and 19 to 21, where the crystal grain size of unstabilized zirconia was 0.1 times to 0.5 times the crystal grain size of titanium nitride, a high compressive stress was applied to the crystal grains of titanium nitride due to volume expansion of the crystal grains of unstabilized zirconia, and therefore worn-out depth was as small as 2.2 μm or less, indicating even higher wear resistance.

Comparison between specimen No. 3 and specimen No. 5 and between specimen No. 4 and specimen No. 6 that were different only in the size of titanium nitride powder (mean particle size) used as the raw material showed that specimens Nos. 5 and 6 showed small worn-out depth because the crystal grain size of unstabilized zirconia was 0.5 times or less the crystal grain size of titanium nitride, and it was found that relative crystal grain size of unstabilized zirconia to the grain size of titanium nitride had an influence on the wear resistance. In specimen No. 18 in which the crystal grain size of unstabilized zirconia was less than 0.1 times the crystal grain size of titanium nitride, relative crystal grain size of unstabilized zirconia to the crystal grain size of titanium nitride was small and therefore much effect of improving the wear resistance could not be achieved.

In comparison between specimens Nos. 5 to 9 that were the same in purity and mean particle size of the raw material powder used in firing temperature and unstabilized zirconia content but were different in nickel content, it was found that specimens Nos. 6 to 8 showed high fracture toughness because nickel content was 4% by mass to 8% by mass and the crystal grains of titanium nitride were bonded firmly with each other, while silver color of nickel exerted no substantial influence on the color tone of the specimens that was defined by the golden color of titanium nitride, indicating that this constitution is preferable.

In comparison between specimens Nos. 19 to 21 that had the same content of the components but were different in firing temperature, crystal grains of titanium nitride were less likely to come off because the compressive stress applied to the crystal grains of titanium nitride was as high as 350 MPa or more in specimens Nos. 20 and 21 that were fired at 1,600° C. or higher firing temperature. The least worn-out depth was observed in specimen No. 21 that contained much unstabilized zirconia in a range of 6% by mass or more and 30% by mass or less and was fired at 1,650° C.

### Example 2

A titanium nitride powder having purity of 99% and a mean particle size of 10 μm, a zirconia powder having purity of 99.5% and a mean particle size of 1 μm that does not substantially contains a stabilizing agent, and a nickel powder having purity of 99.5% and a mean particle size of 14 μm were weighed so that the contents of each component in the obtained sintered body become the contents of unstabilized zirconia and nickel shown in Table 3, and then mixed to obtain a prepared material.

Next, methanol as a solvent was added to each prepared material, followed by mixing and grinding for 120 hours in a vibration mill. A binder (3% by mass) such as polyethylene glycol was added to the prepared material, followed by mixing. The obtained slurry was dried by a spray drying method to obtain granules. The obtained granules were formed into a disk-shaped green compact under a pressure of 98 MPa. Next, the obtained disk-shaped green compact was degreased in a nitrogen atmosphere at 600° C. and then allowed to stand in a nitrogen atmosphere at the firing temperature of 1,620° C. for 2 hours to obtain a disk-shaped sintered body measuring 16 mm in diameter and 2 mm in thickness.

The disk-shaped sintered material was lapped by using a diamond paste to obtain the ceramics for decorative part of specimens Nos. 24 to 29 having surface roughness in a range of 0.05 μm or more and 0.23 μm or less in terms of an arithmetic mean height Ra defined in JIS B 0601-2001.

Then contents of unstabilized zirconia and nickel were determined by the same method as that of Example 1. Further, the color tones on the surfaces of the ceramics for decorative part were measured for specimens Nos. 24 to 29 in accordance to JIS Z 8722-2000, using a spectrocolorimeter (CM-3700d from Konica Minolta Holdings Inc., etc.) in combination with CIE standard light source of D65 with view angle being set to 10 degrees, the measurement area being set to 3 mm×5 mm and spot area set to 5 mm×7 mm.

The color tone was evaluated by 40 monitors comprising 5 male and 5 female monitors in each of 4 age brackets from 20s to 50s, by responding to questionnaire asking how they felt about 3 aspects of quality; high-grade impression, aesthetic satisfaction and mind soothing effect. It was decided that the specimen was “excellent” when 90% or more of the monitors responded “positively” for any one of the high-grade impression, aesthetic satisfaction and mind soothing effect and 100% of the monitors responded positively for the other quality items, “good” when 90% or less of the monitors responded positively for two of the three quality items. Results of color tone measurements and the questionnaire study are shown in Table 3.

TABLE 3

| | Unstabilized | | | | | High-Grade | Aesthetic | | |
|---|---|---|---|---|---|---|---|---|---|
| Specimen | Zirconia | Nickel | Lightness | Chromaticness | Chromaticness | Impression | Satisfaction | Mind Soothing | Color Tone |
| No. | (% by mass) | (% by mass) | Index L* | Index a* | Index b* | (%) | (%) | Effect (%) | Evaluation |
| 24 | 29 | 5 | 56 | 7 | 21.3 | 90 | 100 | 90 | Good |
| 25 | 28 | 5 | 60 | 6 | 16.5 | 100 | 90 | 100 | Exellent |
| 26 | 21 | 5 | 63 | 6.5 | 17.6 | 100 | 100 | 100 | Exellent |
| 27 | 14 | 5 | 65 | 7.2 | 21 | 100 | 100 | 90 | Exellent |
| 28 | 7 | 5 | 70 | 8.2 | 24.5 | 100 | 100 | 90 | Exellent |
| 29 | 6 | 5 | 72 | 6 | 26.8 | 100 | 90 | 90 | Good |

As is apparent from the results shown in Table 3, 90% or more of the monitors responded “positively” for each of the high-grade impression, aesthetic satisfaction and mind soothing effect for specimens Nos. 24 to 29 that were ceramics for decorative part of the present invention. Specimens Nos. 25 to 28 showed lightness index L* in a range of 60 or more and 70 or less, chromaticness index a* in a range of 6.0 or more and 8.2 or less, and chromaticness index b* in a range of 16.5 or more and 24.5 or less in the L*a*b* color space of CIE1976 of the decorative surface, and were evaluated by the monitors higher in terms of high-grade impression, aesthetic satisfaction and mind soothing effect, with color tone evaluated as “excellent”, thus showing that the color tone of the ceramics for decorative part of the present invention was highly evaluated,

### Example 3

A titanium nitride powder having purity of 99% and a mean particle size of 12 μm, a zirconia powder having purity of 99.5% and a mean particle size of 1.5 μm that does not substantially contains a stabilizing agent, and a nickel powder having purity of 99.5% and a mean particle size of 6.7 μm were weighed so that the contents of each component in the obtained sintered body become the contents of unstabilized zirconia and nickel shown in Table 4, and then mixed to obtain a prepared material. In specimen No. 30, chromium carbide was added.

Next, methanol as a solvent was added to each prepared material, followed by mixing and grinding for 120 hours in a vibration mill. A binder (3% by mass) such as polyethylene glycol was added to the prepared material, followed by mixing. The obtained slurry was dried by a spray drying method to obtain granules. The obtained granules were formed into a disk-shaped green compact under a pressure of 98 MPa. Next, the obtained disk-shaped green compact was degreased in a nitrogen atmosphere at 600° C. and then allowed to stand in a nitrogen atmosphere at the firing temperature of 1,620° C. for 2 hours to obtain a disk-shaped sintered body measuring 16 mm in diameter and 2 mm in thickness.

The disk-shaped sintered material was lapped by using a diamond paste to obtain the ceramics for decorative part of specimens Nos. 30 and 31 having surface roughness in a range from 0.05 to 0.23 μm in terms of an arithmetic mean height Ra defined in JIS B 0601-2001.

Then contents of unstabilized zirconia and nickel were determined by the same method as that of Example 1. Chromium content was also determined by the ICP emission spectrometry analysis. Then the color tones on the decorative surfaces of the ceramics for decorative part were measured in accordance to JIS Z 8722-2000, using a spectrocolorimeter (CM-3700d from Konica Minolta Holdings Inc., etc.) in combination with CIE standard light source of D65 with view angle being set to 10 degrees, the measurement area being set to 3 mm×5 mm and spot area set to 5 mm×7 mm. After the measurement, specimens Nos. 30 and 31 were subjected to semi-immersion in artificial sweat test (leaving to stand at 23±2° C. for 24 hours), among the corrosion resistance tests specified in JIS B 7001-1995. After the corrosion resistance test, color tone was measured on the surfaces of specimens Nos. 30 and 31 by the same method as described above. The results are shown in Table 4.

TABLE 4

| | | | | Lightness Indes | | | Chromaticness Index | | | Chromaticness Index | | |
|---|---|---|---|---|---|---|---|---|---|---|---|---|
| | | | | L* | | | a* | | | b* | | |
| | Unstabalized | | | Before | After | | Before | After | | Before | After | |
| Specimen | Zirconia | Nickel | Chromium | the | the | | the | the | | the | the | |
| No. | (% by mass) | (% by mass) | (% by mass) | Test | Test | Difference | Test | Test | Difference | Test | Test | Difference |
| 30 | 27 | 6 | 3.5 | 64 | 64 | 0 | 7.4 | 7.3 | 0.1 | 21.5 | 21.4 | 0.1 |
| 31 | 27 | 6 | 0 | 64 | 62.1 | 1.9 | 7.8 | 8.2 | −0.4 | 23 | 22.9 | 0.1 |

As is apparent from Table 4, compared to specimen No. 31 that did not contain chromium, specimen No. 30 that contained chromium showed less variations in lightness index L* and chromaticness index a* before and after the test. This showed that contained chromium improves corrosion resistance as chromium bonds with oxygen in the atmosphere so as to form a dense oxide film on the decorative surface. It was found that this makes it possible to provide users with high-grade impression, aesthetic satisfaction and mind soothing effect over a long period of time.

### Example 4

First, titanium nitride powder having purity of 99% and a mean particle size of 12 μm, a zirconia powder having purity of 99.5% and a mean particle size of 1.5 μm that does not substantially contains a stabilizing agent, a nickel powder having purity of 99.5% and a mean particle size of 6.7 μm, a chromium carbide powder having purity of 99% and a mean particle size of 7 μm and a manganese carbonate powder having purity of 99.9% and a mean particle size of 18.8 μm were weighed so that the contents of each component in the obtained sintered body become the contents of unstabilized zirconia, nickel, chromium and manganese in Table 5, and then mixed to obtain a prepared material.

Next, in the same method as in Example 3, specimens Nos. 32 to 35 of ceramics for decorative part were obtained. Manganese carbonate was decomposed during firing and thus carbon dioxide and oxygen were burned out from manganese carbonate. In ceramics for decorative part, it was present as manganese.

Chromium carbide was also decomposed during firing and thus carbon was burned out from manganese carbonate. In ceramics for decorative part, it was present as chromium.

Thereafter, the contents of unstabilized zirconia and nickel were determined in the same manner as in Example 1. The contents of chromium and manganese were also determined by ICP emission spectrometry. Each color tone at one position at the center and 4 positions of the peripheral portions of a surface was measured, and then a mean value and standard deviation were calculated. The results are shown in Table 5.

TABLE 5

| | | | | | Lightness Index | | Chromaticness Index | | Chromaticness Index | |
|---|---|---|---|---|---|---|---|---|---|---|
| | Unstabalized | | | | L* | | a* | | b* | |
| Specimen | Zirconia | Nickel | Chromium | Manganese | | Standard | | Standard | | Standard |
| No. | (% by mass) | (% by mass) | (% by mass) | (% by mass) | Mean Value | deviation | Mean Value | deviation | Mean Value | deviation |
| 32 | 9 | 5 | 3.5 | 0 | 69 | 0.3 | 7.9 | 0.2 | 22.4 | 0.3 |
| 33 | 9 | 5 | 3.5 | 0.2 | 69 | 0.2 | 7.9 | 0.2 | 22.4 | 0.3 |
| 34 | 9 | 5 | 3.5 | 0.3 | 69 | 0.2 | 7.9 | 0.1 | 22.4 | 0.2 |
| 35 | 9 | 5 | 3.5 | 0.4 | 69 | 0.1 | 7.9 | 0.1 | 22.4 | 0.1 |

As is apparent from the results shown in Table 5, compared to specimen No. 32 that did not contain manganese, specimens Nos. 33 to 35 that contained manganese preferably showed less variations in color tone of the surface because the granules obtained by spray drying method were hardly oxidized.

The ceramics for decorative part of the present invention was used to fabricate the fish line guide ring that is a decorative part for fish line guide, the watch case and links of watch band that are decorative parts for watch and the various control keys of mobile phone that are decorative parts for mobile terminal such as. It was proved that every specimen of the decorative parts had high wear resistance and was hard to be damaged on the surface, so that golden color tone can be maintained over a long period of time. As a result, it was found that use of the ceramics for decorative part in these decorative parts makes it possible to provide attractive products that continue to give high-grade impression, aesthetic satisfaction and mind soothing effect over a long period of time.

The present international application claims priority on Japanese Patent Application No. 2008-075827 filed on Mar. 24, 2008, the disclosure of which is incorporated by reference herein.

1. A ceramic for a decorative part, comprising 50% by mass or more of titanium nitride, 6% by mass or more and 30% by mass or less of unstabilized zirconia containing substantially no stabilizing agent, and nickel,
wherein the crystal grain size of the unstabilized zirconia is smaller than the crystal grain size of the titanium nitride.

2. The ceramic for a decorative part according to claim 1,
wherein the crystal grain size of the unstabilized zirconia is 0.1 times or more and 0.5 times or less of the 15 crystal grain size of the titanium nitride.

3. The ceramic for a decorative part according to claim 1,
wherein the content of the nickel is 4% by mass or more and 8% by mass or less.

4. The ceramic for a decorative part according to claim 1,
wherein 350 MPa or more compression stress is applied to crystal grains of the titanium nitride.

5. The ceramic for a decorative part according to claim 1,
wherein the ceramic comprises a decorative surface having a lightness index L* of 60 or more and 70 or less, a chromaticness index a* of 6.0 or more and 8.2 or less and a chromaticness index b* of 16.5 or more and 24.5 or less in the L*a*b* color space of CIE1976.

6. The ceramic for a decorative part according to claim 1, further comprising chromium.

7. The ceramic for a decorative part according to claim 1, further comprising manganese.

8. The ceramic for a decorative part according to claim 1,
wherein the thermal conductivity of the ceramic is 20 W/(m-K) or more and 26 W/(m-K) or less.

9. A decorative part for a fish line guide comprising the ceramic for a decorative part according to claim 1.

10. A decorative part for a watch comprising the ceramic for a decorative part according to claim 1.

11. A decorative part for a mobile terminal comprising the ceramic for a decorative part according to claim 1.

12. A decorative part for a daily life article comprising the ceramic for a decorative part according to claim 1.

13. A decorative part for a vehicle part comprising the ceramic for a decorative part according to claim 1.

14. A decorative part for sports goods comprising the ceramic for a decorative part according to claim 1.

15. A decorative part for a musical instrument comprising the ceramics for a decorative part according to claim 1.

16. A decorative part for an accessory comprising the ceramics for a decorative part according to claim 1.
